(19) United States
(12) Patent Application Publication
(10) Pub. No.: US 2026/0336385 A1
(43) Pub. Date: Oct. 29, 2026

(54) VEHICLE WITH GRILLE ASSEMBLY

(71) Applicant: Oshkosh Defense, LLC, Oshkosh, WI (US)

(72) Inventors: Sam Barwick, Oshkosh, WI (US); Tim Snyder, Oshkosh, WI (US); Jenni Atkinson, Oshkosh, WI (US); Mike Wrege, Oshkosh, WI (US); Skeets Sommerfeldt, Oshkosh, WI (US); Ryan Kuhlman, Oshkosh, WI (US); Brian Bartley, Hartland, MI (US); Ben LeVesque, Royal Oak, MI (US)

(21) Appl. No.: 19/051,986

(22) Filed: Feb. 12, 2025

Related U.S. Application Data
(63) Continuation of application No. 18/894,957, filed on Sep. 24, 2024, now abandoned.
(60) Provisional application No. 63/540,185, filed on Sep. 25, 2023.
(60) Provisional application No. 63/676,993, filed on Jul. 30, 2024.

(51) Int. Cl. B60K 11/08; B21D 22/02

(52) U.S. Cl. CPC B60K 11/08; B21D 22/022

(57) ABSTRACT

A vehicle includes a chassis, a body coupled to the chassis, and a grille assembly coupled to the body. The grille assembly includes a grille frame assembly coupled to the body and a plurality of grille slats coupled to the grille frame assembly. The plurality of grille slats are spaced across the grille frame assembly to define a plurality of grille openings through the grille assembly that provide indirect paths through the grille assembly.

### CROSS-REFERENCE TO RELATED PATENT APPLICATION

This application is a continuation of U.S. application Ser. No. 18/894,957, filed Sep. 24, 2024, which claims the benefit of and priority to U.S. Provisional Patent Application No. 63/540,185, filed Sep. 25, 2023, and U.S. Provisional Patent Application No. 63/676,993, filed Jul. 30, 2024, the disclosures all of which are incorporated herein by reference in their entireties.

### STATEMENT REGARDING FEDERALLY-SPONSORED RESEARCH OR DEVELOPMENT

This invention was made with Government support under contract W15QKN-17-9-1025, awarded by the Department of Defense. The Government has certain rights in this invention.

### BACKGROUND

The present disclosure relates to a tracked vehicle. More particularly, the present disclosure relates to a remotely controlled vehicle.

### SUMMARY

One embodiment relates to a vehicle. The vehicle includes a chassis, a body coupled to the chassis, and a grille assembly coupled to the body. The grille assembly includes a grille frame assembly coupled to the body and a plurality of grille slats coupled to the grille frame assembly. The plurality of grille slats are spaced across the grille frame assembly to define a plurality of grille openings through the grille assembly that provide indirect paths through the grille assembly.

Another embodiment relates to a grille assembly configured to couple to a body of a vehicle. The grille assembly includes a grille frame assembly configured to couple to the body and a plurality of grille slats. The grille frame assembly includes a mounting bracket configured to couple to the body and a pair of side brackets coupled the mounting bracket at opposing sides of the mounting bracket. The mounting bracket defines an intake opening extending through the mounting bracket. Each of the side brackets define a first plurality of apertures. The plurality of grille slats are coupled to the mounting bracket and align with and extend through the first plurality of apertures. The plurality of grille slats are spaced across the grille frame assembly to define a plurality of grille openings through the grille assembly that provide indirect paths through the grille assembly.

Still another embodiment relates to method of forming a grille slat. The method includes heating a blank to a predetermined temperature, forming the blank into the grille slat using a die, and quenching the grille slat. The die applies pressure on the blank and a temperature of the blank is above a forming temperature. Quenching the grille slat includes submerging the grille slat in a fluid to decrease the temperature of the grille slat.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a vehicle, according to some embodiments.

FIG. 2 is a top view of a rear portion of the vehicle of FIG. 1 including an electric drive system, according to some embodiments.

FIG. 3 is a block diagram of a driveline of the vehicle of FIG. 1, according to some embodiments.

FIG. 4 is a block diagram of a control system for the vehicle of FIG. 1, according to some embodiments.

FIG. 5 is a perspective cross-section view of a portion of an example armored grille of the vehicle of FIG. 1 taken about plane A-A, according to some embodiments.

FIG. 6 is a side, cross-section view of the armored grille of FIG. 5 taken about plane A-A, according to some embodiments.

FIG. 7 is a detailed cross-section view of a grille of the armored grille of FIG. 5 taken at Detail A, according to some embodiments.

FIG. 8 is a perspective cross-section view of a portion of another example armored grille of the vehicle of FIG. 1 taken about plane A-A, according to some embodiments.

FIG. 9 is a side, cross-section view of the armored grille of FIG. 8 taken about plane A-A, according to some embodiments.

FIG. 10 is a detailed cross-section view of a grille of the armored grille of FIG. 8 taken at Detail B, according to some embodiments.

FIG. 11 is a front perspective view of another example armored grille of the vehicle of FIG. 1, according to some embodiments.

FIG. 12 is a rear perspective view of the armored grille of FIG. 11, according to some embodiments.

FIG. 13 is a side view of the armored grille of FIG. 11, according to some embodiments.

FIG. 14. is a perspective cross-section view of the armored grille of FIG. 11 taken about plane B-B, according to some embodiments.

FIG. 15 is a top cross-section view of a portion the armored grille of FIG. 11 taken about plane B-B at Detail C, according to some embodiments.

FIG. 16 is a detailed cross-section view of a grille of the armored grill of FIG. 11, according to some embodiments.

FIG. 17 is a block diagram of an example method for manufacturing a grille slat of an armored grill assembly, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, an armored grille assembly for a military vehicle includes a grille frame assembly and a plurality of grille slats attached to the grille frame assembly. The grille slats are spaced across the grill frame assembly to provide a plurality of grille openings through the armored grille assembly that provide an indirect path through the armored grille assembly. The indirect path through the armored grille assembly may be configured to allow for air to pass through the armored grille assembly while redirecting a path of a projectile when the projectile comes in contact with the grille slats the armored grille assembly while passing through the grille openings of the armored grille assembly. The redirection of the path of the projectile may reduce a velocity of the projectile coming in contact with the grille slates of the armored grille assembly such that a first velocity of the projectile before passing through the armored grille assembly is greater than a second velocity of the projectile after passing through the armored grille assembly. In some embodiments, the redirection of the path of the projectile may reduce the velocity of the projectile such that the projectile does not fully pass through the armored grille assembly. The grille slats include a bottom surface that follows a bottom curvature from an external end of each of the plurality of grille slats to an internal end of each of the plurality of grille slats and a top surface that follows a top curvature from the external end of each of the plurality of grille slates to the internal end of each of the plurality of grille slates. In some embodiments, the grille slats may be configured as bent knee grille slats or chevron grille slats.

The grille slats of the armored grille assembly may be formed following a hot stamping process. The hot stamping process includes heating a blank to a predetermined temperature, forming the blank into a grille slat using a die, and quenching the grille slat. To form the blank into the grille slat, the die applies pressure on the blank while a temperature of the blank is above a forming temperature. To quench the grille slat, the grille slat is submerged in a fluid to decrease the temperature of the grille slat. The hot stamping process may include performing additional machining processes to finish forming the grille slat.

### Tracked Vehicle

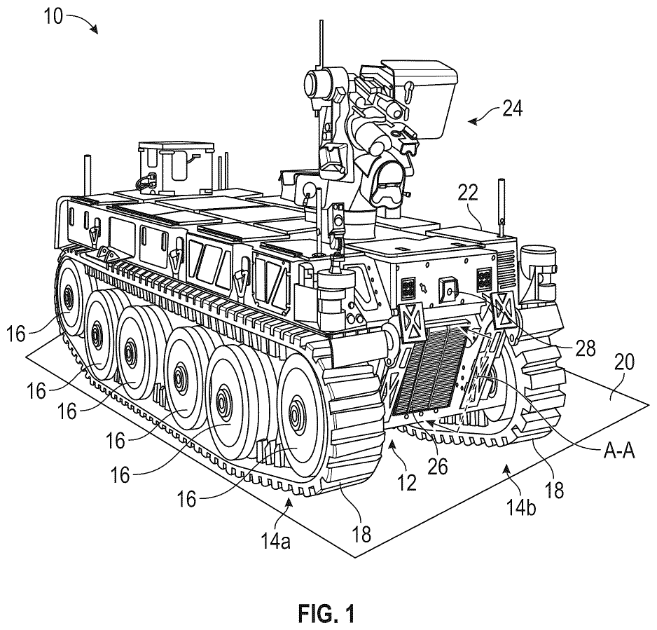

Referring to FIG. 1, a vehicle 10 (e.g., a robotic vehicle, a combat vehicle, an autonomous vehicle, a semi-autonomous vehicle, a remotely controlled combat or fighting vehicle, etc.) includes a body 22 that is coupled with and positioned on a chassis 12 (e.g., a frame). The vehicle 10 may be a tracked vehicle including a first track assembly 14a and a second track assembly 14b positioned on opposite lateral sides of the body 22. The track assemblies 14 are configured to be driven (e.g., by a drive drum) to drive transportation of the vehicle 10 along a ground surface 20. In some embodiments, the track assemblies 14 include multiple followers that are rotatably coupled with the body 22 or the chassis and are driven to rotate by movement of the tracks 18. The track assemblies 14 each include multiple rotatable elements 16 (e.g., drums, wheels, gears, sprockets, cylindrical members, etc.) that may include one or more driven rotatable elements and one or more follower rotatable elements. The track assemblies 14 also each include tracks 18 that have the form of an elongated and closed loop member (e.g., a tread, a rubber track, a resilient material formed in a loop, etc.). The driven rotatable elements may engage an inner surface of the tracks 18 in order to drive rotation or movement of the tracks 18 to transport the vehicle 10.

The vehicle 10 may be a fighting vehicle, a manned vehicle, a military vehicle, an electric military vehicle, an unmanned vehicle, a robotic combat vehicle, etc. The vehicle 10 can include weaponry 24 positioned around the body 22, various telematics or wireless control units, a control system, etc., such that the vehicle 10 can be transported by a remote operator. The vehicle 10 may include one or more sensors 28 (e.g., infrared sensors, cameras, imaging devices, forward looking infrared, lidar sensors, radar sensors, microphones, threat detection systems, etc.) positioned about the body 22. The body 22 may be armored in order to reduce a likelihood of puncture by hostile rounds or weaponry.

The body 22 may also include a grille 26 that includes multiple structural members and openings. The grille 26 may be positioned at a longitudinal end (e.g., a front or forwards facing longitudinal end, a rear or rearwards facing longitudinal end,) of the body 22 and may allow air to transfer into the body 22 to cool components of the vehicle 10.

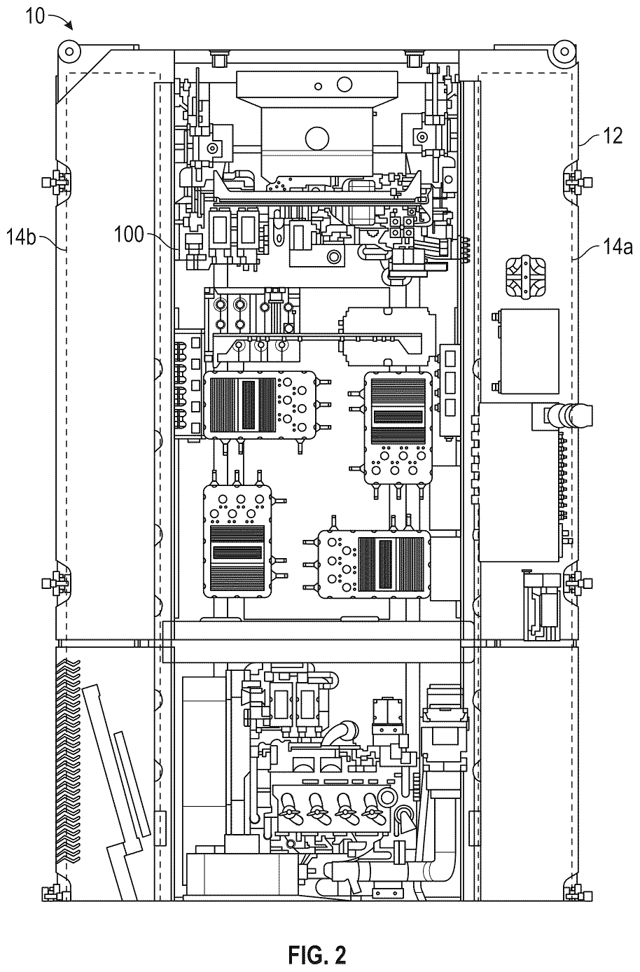

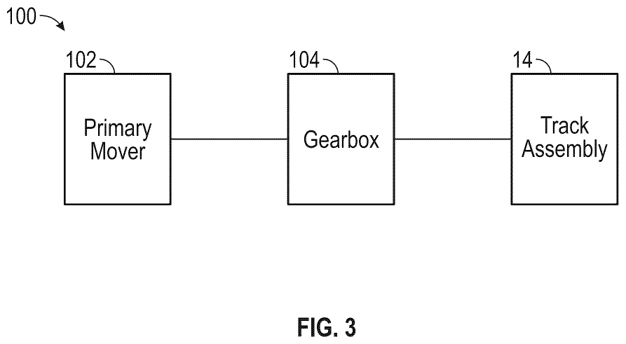

Referring to FIGS. 2 and 3, the vehicle 10 includes a driveline 100 (e.g., a drive system) that is configured to drive one or more rollers, drums, etc., of the track assemblies 14 to thereby drive the tracks 18 and transport the vehicle 10. The vehicle 10 may include a separate driveline 100 for each of the first track assembly 14a and the second track assembly 14b and may operate the drivelines 100 at different speeds in order to perform steering or turning for the vehicle 10. The driveline 100 may be an electric drive system such that the vehicle 10 uses on-board electrical energy (e.g., batteries, capacitors, cells, energy store systems, etc.) to transport.

As shown in FIG. 3, the driveline 100 may include a primary mover 102 (e.g., an engine, an electric motor, etc.), a gearbox 104, and the track assemblies 14. The driveline 100 may include multiple of the primary movers 102 and gearboxes 104 in order to independently drive the first track assembly 14a and the second track assembly 14b at different rates or in different directions to perform turns or steering operations. The gearbox 104 is configured to receive output torque from the primary mover 102 and transfer torque to the driven rotatable elements of the track assemblies 14 to drive the tracks 18 for both transportation and steering of the vehicle 10.

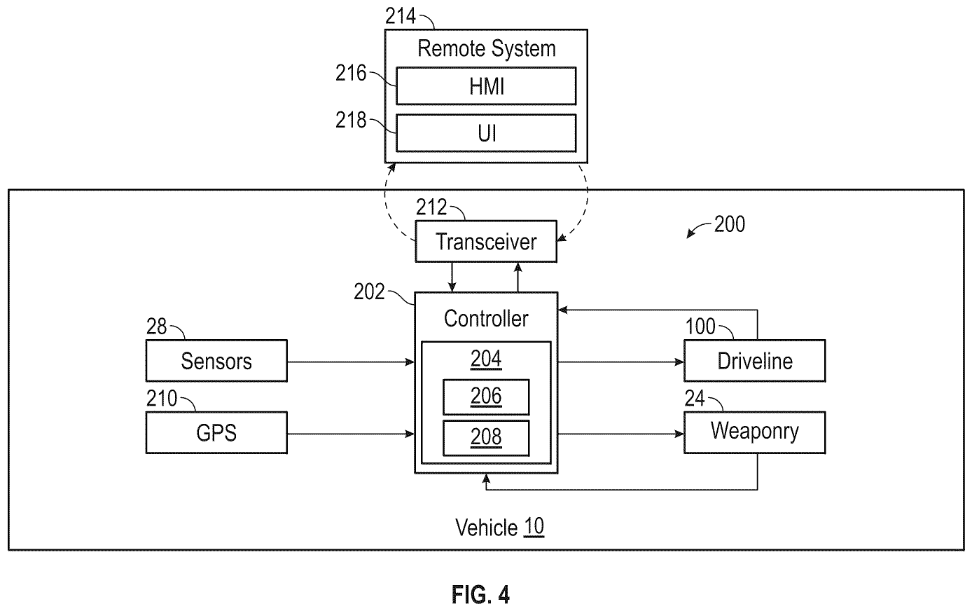

Referring to FIG. 4, the vehicle 10 may include or be a component of a control system 200. The control system 200 includes a controller 202, the sensors 28, a Global Positioning System (“GPS”), the driveline(s) 100, the weaponry 24, a transceiver 212, and a remote system 214. The controller 202 is configured to receive sensor data from the sensors 28 and a GPS location from the GPS 210. The controller 202 may use the sensor data to autonomously control operation of the driveline 100 and the weaponry 24. The controller 202 may also receive feedback from the driveline(s) 100 and the weaponry 24. The controller 202 may communicate with the remote system 214 via the transceiver 212, providing the sensor data, the GPS location, the feedback from the driveline 100, and the feedback from the weaponry 24. The remote system 214 includes a Human Machine Interface (“HMI”) 216 and a user interface (“UI”) 218. The HMI 216 may provide various buttons, input devices, steering wheels, selectors, switches, etc., to obtain an input or requested command for the vehicle 10 from an operator. In some embodiments, the command is a direct command to operate the driveline 100 or the weaponry 24 such that the vehicle 10 is remotely controlled. In some embodiments, the command is a high level command to the vehicle 10 to implement one or more actions such that the vehicle 10 is semi-autonomously controlled.

The controller 202 may also provide any of the sensor data obtained from the sensors 28 (e.g., image data, IR data, FLIR data, threat detection data, radar data, communications, etc.) to the remote system 214 via the transceiver 212. The UI 218 of the remote system 214 may display any of the sensor data, GPS location, or feedback provided to the remote system 214 by the controller 202. In some embodiments, the transceiver 212 of the vehicle 10 is configured to communicate with transceivers 212 of nearby of the vehicles 10 to form a mesh network. The controller 202 may receive commands from the remote system 214 and operate the driveline 100 and the weaponry 24 to implement the commands.

The controller 202 includes processing circuitry 204 including a processor 206 and memory 208. Processing circuitry 204 can be communicably connected with a communications interface of controller 202 such that processing circuitry 204 and the various components thereof can send and receive data via the communications interface. Processor 206 can be implemented as a general purpose processor, an application specific integrated circuit (ASIC), one or more field programmable gate arrays (FPGAs), a group of processing components, or other suitable electronic processing components.

Memory 208 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 208 can be or include volatile memory or non-volatile memory. Memory 208 can include database components, object code components, script components, or any other type of information structure for supporting the various activities and information structures described in the present application. According to some embodiments, memory 208 is communicably connected to processor 206 via processing circuitry 204 and includes computer code for executing (e.g., by at least one of processing circuitry 204 or processor 206) one or more processes described herein.

The remote system 214 may be structurally similar to the controller 202 and can include processing circuitry, processors, memory, etc. The remote system 214 may be physically remote from the vehicle 10. The remote system 214 may represent a single processing unit or may include multiple processing units or servers that implement any of the processes or techniques described herein in a distributed manner.

### Grille Assembly

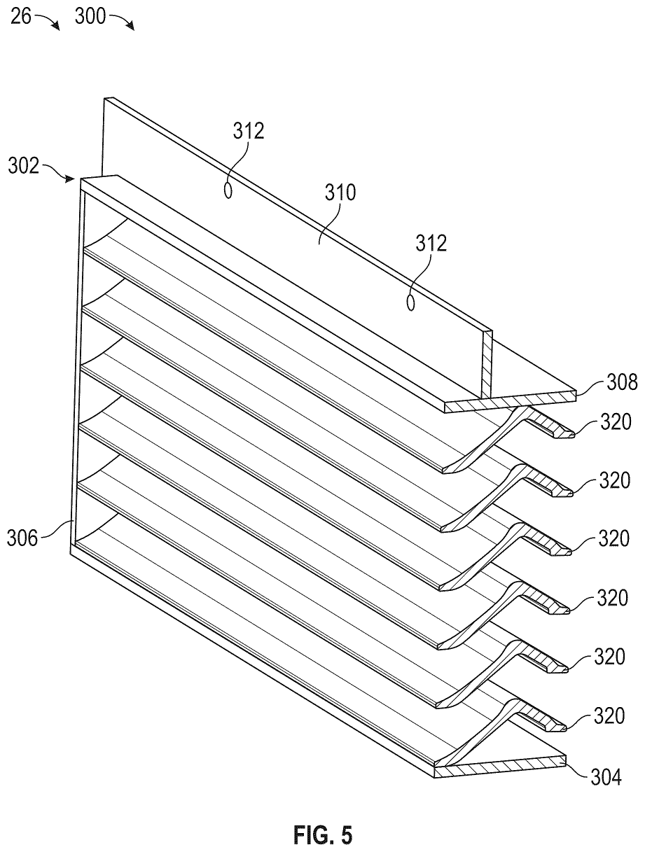

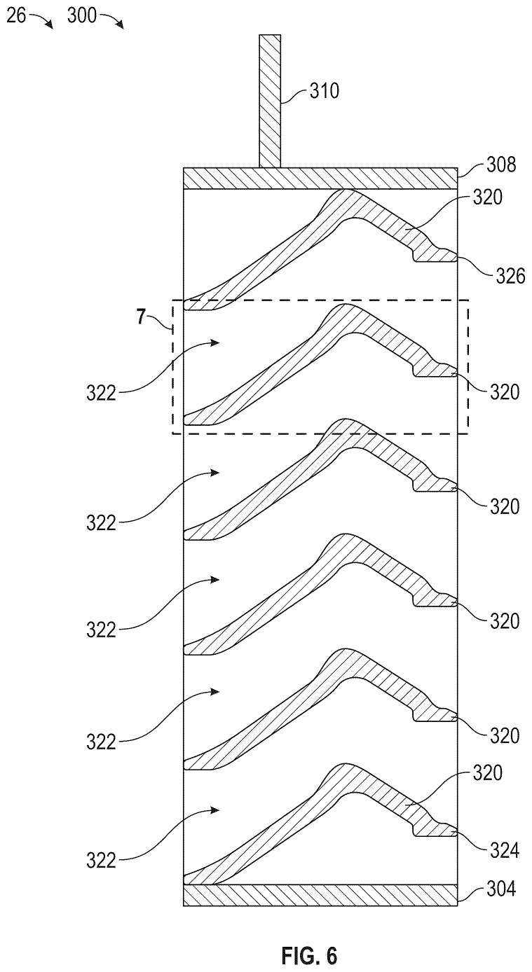

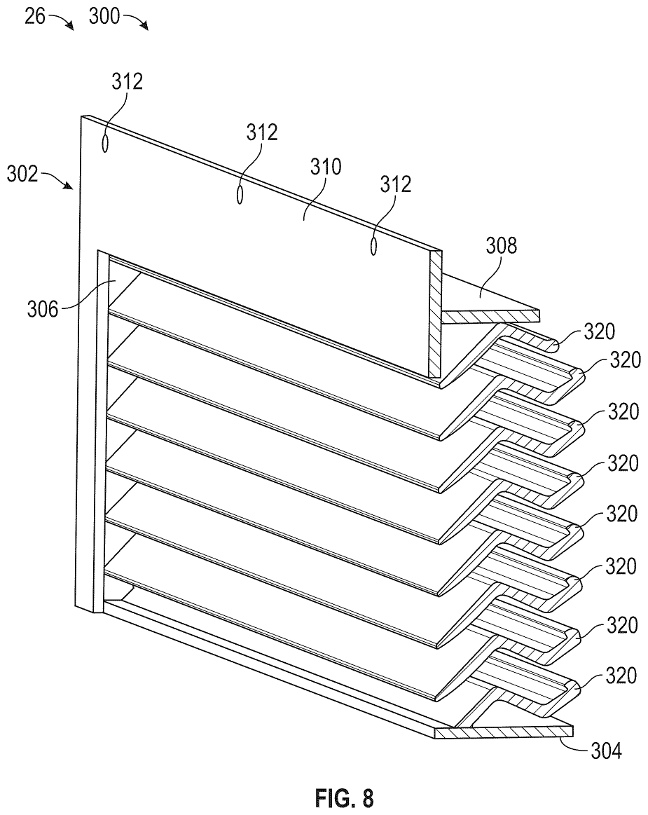

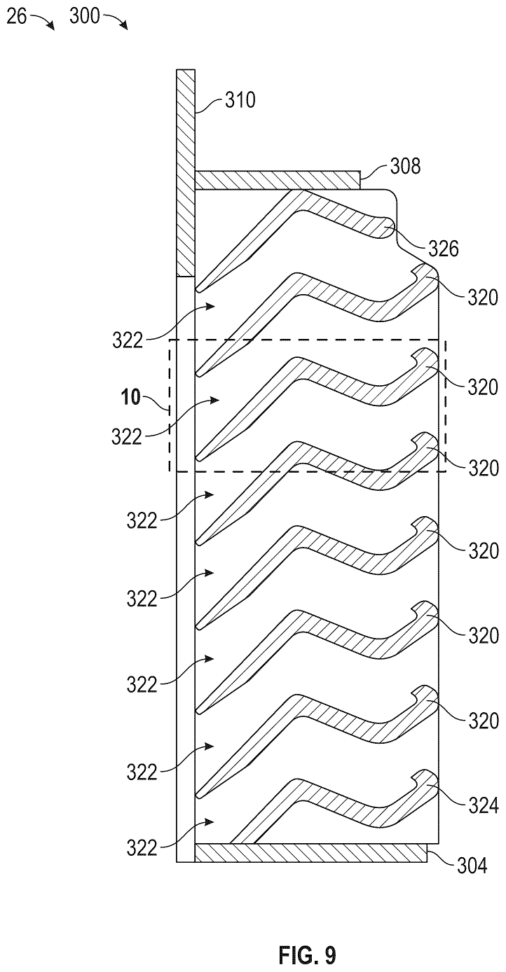

Referring to FIGS. 5, 6, 8, 9, and 11-14, the grille 26 is configured as grille assembly 300 (e.g., an armored grille assembly, etc.), according to some embodiments. The grille assembly 300 includes grille frame assembly 302 and a plurality of grille slats 320 coupled to the grille frame assembly 302. According to the embodiments shown in FIGS. 5, 6, 8, and 9, the grille frame assembly 302 includes a bottom bracket 304 (e.g., bottom member, bottom panel, bottom plate, etc.), a pair of side brackets 306 (e.g., side members, side panels, side plates, etc.), a top bracket 308 (e.g., top member, top panel, top plate, etc.), and a mounting bracket 310 (e.g., mounting member, mounting panel, mounting plate, front bracket, face bracket, etc.) configured to releasably couple the grille assembly 300 to the body 22 of the vehicle 10. A first end of each of the side brackets 306 is coupled to the bottom bracket 304 at opposing ends of the bottom bracket 304 (e.g., at a first end of the bottom bracket 304 and at a second opposing end of the bottom bracket 304, etc.) and a second opposing end of each of the side brackets 306 is coupled to the top bracket 308 at opposing end of the top bracket 308 (e.g., at a first end of the top bracket 308 and at a second opposing end of the top bracket 308, etc.). According to the embodiment shown in FIGS. 5 and 6, the mounting bracket 310 is coupled to a top surface of the top bracket 308. For example, the mounting bracket 310 may be coupled to and extend upwards from the top surface of the top bracket 308 and/or may be centered on the top surface of the top bracket 308 across a width of the top bracket 308. According to the embodiment shown in FIGS. 8 and 9, the mounting bracket 310 is coupled to a front face of the top bracket 308 and a front face of each of the pair of side brackets 306. For example, the mounting bracket 310 may be positioned forward of the top bracket 308 and the side brackets 306 and may extend across a front of the top bracket 308 and downward across a front of the side brackets 306. In some embodiments, the bottom bracket 304, the pair of side brackets 306, the top bracket 308, and the mounting bracket 310 are integrally formed (e.g., form a single weldment, welded, etc.). In other embodiments, one or more components of the grille frame assembly 302 are otherwise coupled together (e.g., fastened, adhered, etc.).

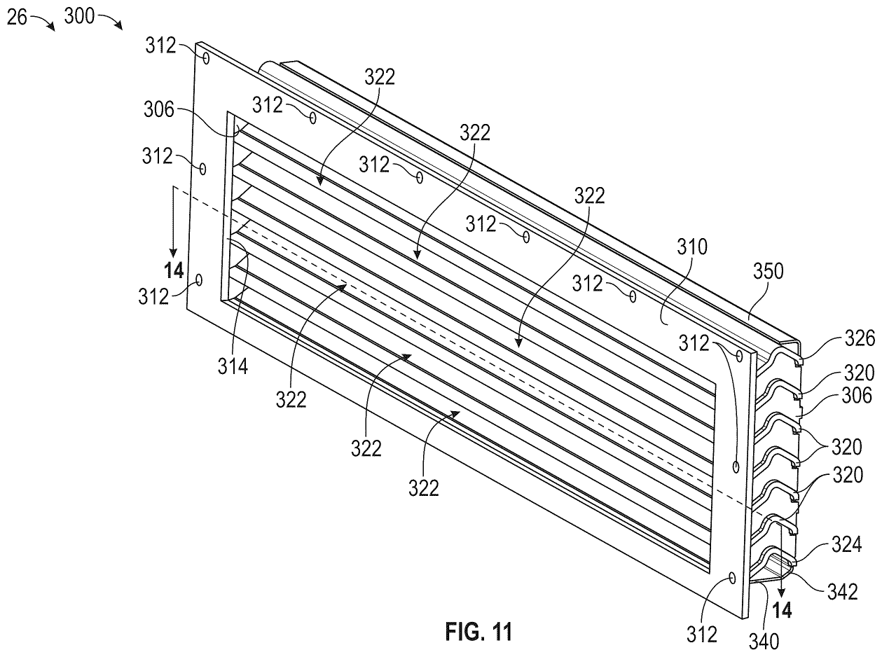

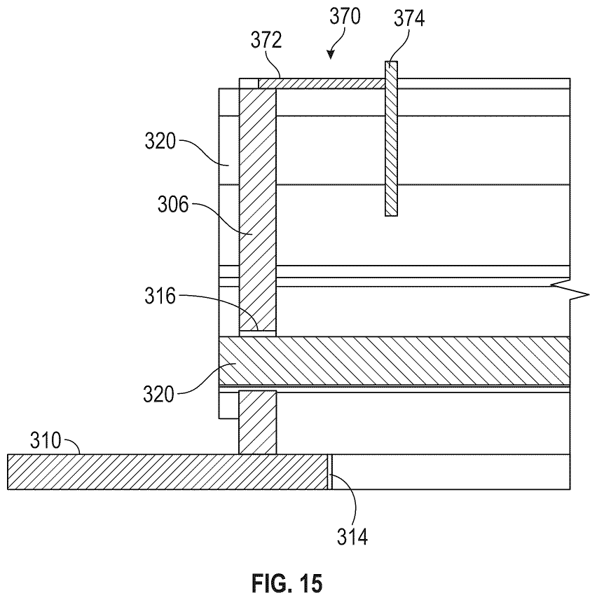

According to the embodiment shown in FIG. 11-15, the grille frame assembly 302 includes the side brackets 306 and the mounting bracket 310 and does not include the bottom bracket 304 or the top bracket 308. A front end of each of the side brackets 306 is coupled to a rearward surface of the mounting bracket 310. For example, a first of the side brackets 306 may be coupled to the rearward surface of the mounting bracket 310 at a first end of the mounting bracket 310 and a second of the side brackets 306 may be coupled to the rearward surface of the mounting bracket 310 at a second opposing end of the mounting bracket 310. The side brackets 306 may extend rearward from the rearward surface of the mounting bracket 310. In some embodiments, the pair of side brackets 306 and the mounting bracket 310 are integrally formed (e.g., form a single weldment, welded, etc.). In other embodiments, the pair of side brackets 306 and the mounting bracket 310 are otherwise coupled together (e.g., fastened, etc.).

As shown in FIGS. 5, 8, 11, 12, and 13, the mounting bracket 310 defines a plurality of mounting apertures 312 configured to selectively align with a plurality of apertures defined by the body 22 to receive a plurality of couplers (e.g., screws, bolts, pins, mandrels, fasteners, etc.) to releasable couple the mounting bracket 310 to the body 22, and, thereby, the grille assembly 300 to the body 22. In other embodiments, the mounting bracket 310 is configured to releasable couple the grille assembly 300 to the body 22 using alternate means (e.g., latches of the body 22 that engage the mounting bracket 310, etc.). In still other embodiments, the grille assembly 300 is non-releasably coupled to the body 22 (e.g., the mounting bracket 310 may be welded to a portion of the body 22, etc.).

Still referring to FIGS. 5, 6, 8, 9, and 11-15, the ends of the grille slats 320 are each coupled to one of the pair of side brackets 306 of the grille frame assembly 302. For example, first ends of the grille slats 320 may be coupled to a first of the side brackets 306 and second opposing ends of the grille slates 320 may be coupled to a second of the side brackets 306 such that the grille slats 320 extend (e.g., extend horizontally, etc.) between the first of the side brackets 306 and the second of the side brackets 306. In some embodiments, the grille slats 320 and the pair of side brackets 306 are integrally formed (e.g., form a single weldment, welded, etc.). In other embodiments, the grille slats 320 and the pair of side brackets 306 are otherwise coupled together (e.g., fastened, etc.). In still other embodiments, the ends of the grille slats 320 are each coupled to the bottom bracket 304 or the top bracket 308. For example, the first ends of the grille slats 320 may be coupled to the bottom bracket 304 and the second opposing ends of the grille slats 320 may be coupled to the top bracket 308 such that the grille slats 320 extend (e.g., extend vertically, etc.) between the bottom bracket 304 and the top bracket 308. In yet other embodiments, the grille slats 320 are each coupled to the mounting bracket 310 and extend across the mounting bracket 310. For example, the grille slats 320 may be coupled to a rearward surface of the mounting bracket 310 and extend across a width of the mounting bracket 310.

As shown in FIGS. 6, 9, and 11, the grille slats 320 are spaced apart to form a plurality of grille openings 322 extending between the grille slats 320 that are configured to allow for air to flow through the grille assembly 300. Each of the grille openings 322 may be defined by a pair of the grille slats 320 that are adjacent to each other. For example, a first of the grille openings 322 may be defined by a first of the grille slats 320 and a second of the grille slats 320 positioned below (e.g., directly below, etc.) the first of the grille slats 320 and a second of the grille openings 322 may be defined by the second of the grille slats 320 and a third of the grille slats 320 positioned below (e.g., directly below, etc.) the second of the grille slats 320. As shown in FIGS. 6, 9, and 11, the grille slats 320 are spaced apart along a length of the side brackets 306 to form the grille openings 322. For example, the grille slats 320 may be evenly spaced along the length of the side brackets 306 such that the grille openings 322 formed to be substantially the same shape and/or size. In other embodiments, the grille slats 320 are spaced apart along a length of the bottom bracket 304 and/or the top bracket 308 to form the grille openings 322 (e.g., when the grille slats 320 are coupled to the bottom bracket 304 and the top bracket 308, etc.).

In some embodiments, the grille openings 322 are configured to allow for a sufficient air flow through the grille assembly 300 to cool the components of the vehicle 10 and allow for the vehicle 10 to function properly (e.g., sufficient air flow to cool the driveline 100, sufficient air flow to cool the control system 200, etc.) while reducing a threat of objects (e.g., bullets, debris, projectiles, etc.) entering the vehicle 10 through the grille assembly 300 and posing a risk to the vehicle 10 (e.g., a risk of damaging components of the vehicle 10, etc.). For example, the grille assembly 300 may be configured to allow for air to flow through the grille assembly 300 while redirecting a path of a projectile coming in contact with the grille assembly 300. In some embodiments, the grille assembly 300 is configured to reduce a velocity of an object coming in contact with the grille assembly 300. For example, a projectile passing through the grille assembly 300 may have a first velocity prior to passing through the grille assembly 300 and a second velocity after passing through the grille assembly 300 that is less than the first velocity.

As shown in FIGS. 6 and 9, the grille slats 320 are spaced along the length of the side brackets 306 such that a portion of each of the grille slats 320 overlaps with a portion of an adjacent of the grille slats 320 (e.g., in a direction of the grille openings 322 through the grille assembly 300, in a direction of travel of the vehicle 10, etc.) such that the grille openings 322 provide an indirect path (e.g., an obstructed path, a non-straight path, etc.) through the grille assembly 300. For example, a lower portion of a first of the grille slats 320 may overlap with an upper portion of a second of the grille slats 320 positioned below (e.g., directly below, etc.) the first of the grille slats 320 in a direction through the grille assembly 300 such that the grille openings 322 defined by the first of the grille slats 320 and the second of the grille slats 320 follows an indirect path through the grille assembly 300. In some embodiments, the indirect path of the grille openings 322 through the grille assembly 300 may follow a zig-zag shape. For example, the indirect path of the grille openings 322 through the grille assembly 300 may include a first portion that is oriented upward, a second portion following the first portion that is oriented downward, and a third portion following the second portion that is oriented upward with a portion of the grille assembly 300 (e.g., a portion of one of the grille slats 320, etc.) positioned between the first portion of the grille openings 322 and the second portion of the grille openings 322. In some embodiments, the indirect path of the grille openings 322 through the grille assembly 300 may follow a chevron shape. For example, the indirect path of the grille openings 322 through the grille assembly 300 may include a first portion that is oriented upward and a second portion that is oriented downward with a portion of the grille assembly 300 (e.g., a portion of one of the grille slats 320, etc.) positioned between the first portion of the grille openings 322 and the second portion of the grille openings 322. In other embodiments, the indirect path of the grille openings 322 through the grille assembly 300 may follow another shape (e.g., a circular shape, a rounded shape, an acute angle shape, an obtuse angle shape, etc.).

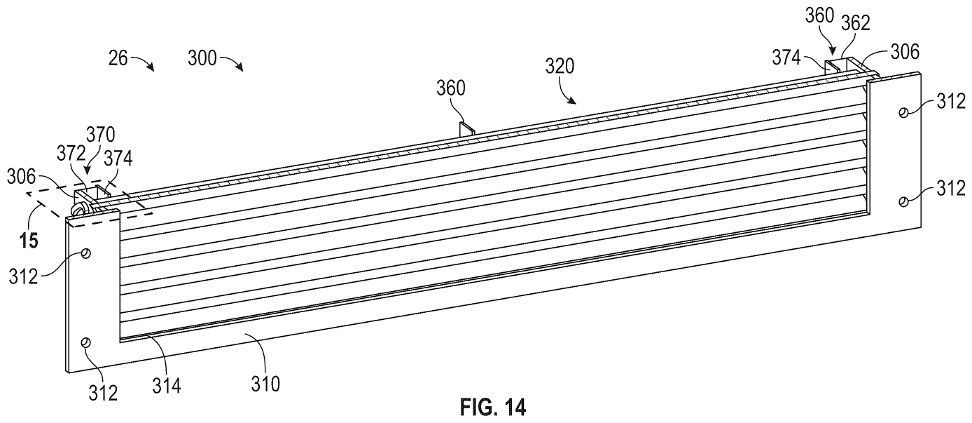

According to the embodiment shown in FIGS. 11 and 14, the mounting bracket 310 defines an intake opening 314 (e.g., a flow-by aperture, etc.) extending through the mounting bracket 310 and aligned with the grille openings 322 to allow for air to flow through the intake opening 314 of the mounting bracket 310 and be provided the grille openings 322 to flow through the grille assembly 300. In other embodiments, the mounting bracket 310 defines a plurality of the intake openings 314 extending through the mounting bracket 310 and configured to allow for air to flow through the intake openings 314 to the grille openings 322. For example, each of the intake openings 314 may align with one of the grille openings 322 defined by the grille slats 320 to allow for air to flow through the intake openings 314 to the grille openings 322 to flow through the grille assembly 300.

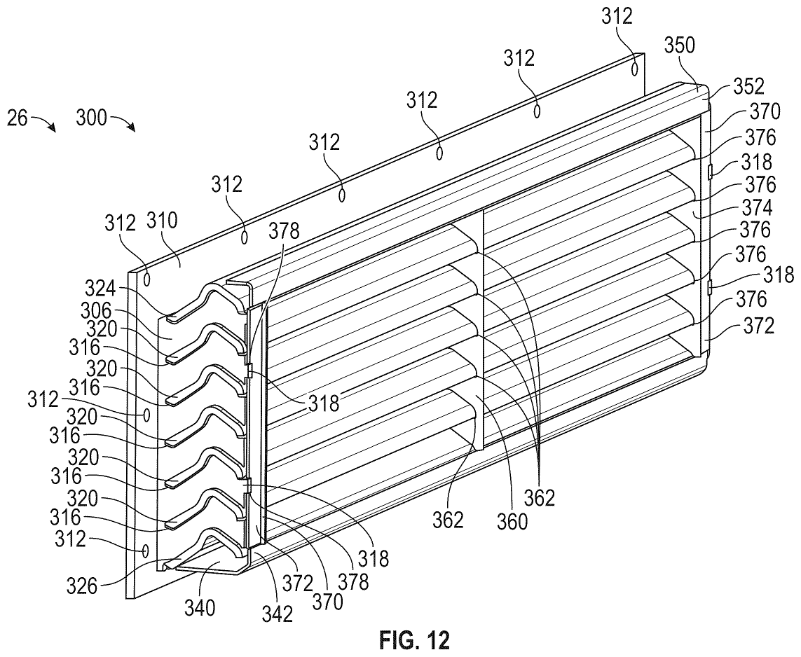

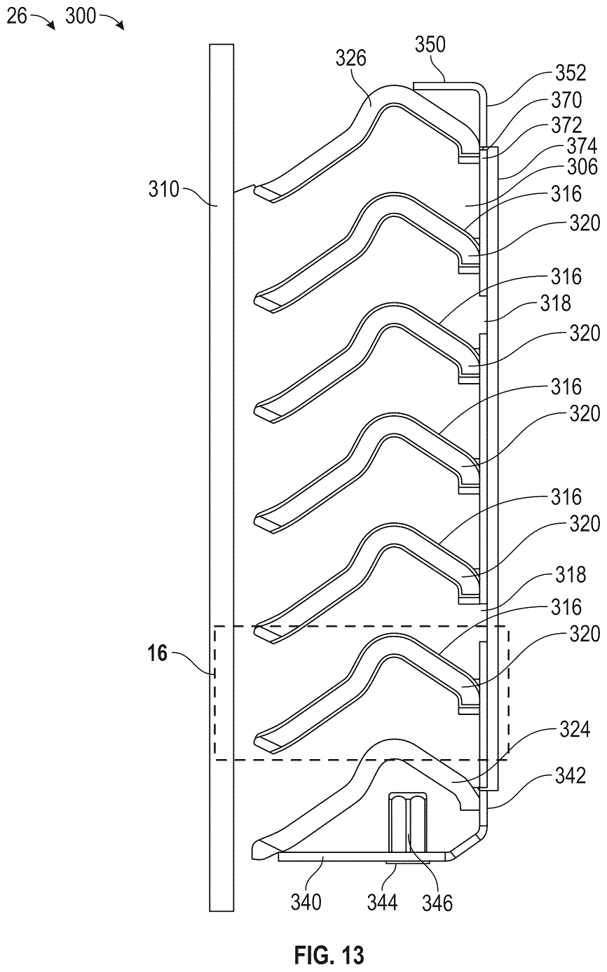

According to the embodiment shown in FIGS. 12, 13, and 15, each of the side brackets 306 defines a plurality of grille apertures 316 configured to align with the grille slats 320 to receive the grille slats 320. For example, to couple the grille slats 320 to the side brackets 306, the grille slats 320 may be aligned with and received by the grille apertures 316. In some embodiments, a profile of the grille apertures 316 may generally match a profile of the grille slats 320 which may assist with aligning the grille slats 320 relative to the grille frame assembly 302 when the grille slats 320 are coupled to the grille frame assembly 302 (e.g., during manufacturing, while being welded together, while being assembled, etc.). In various embodiments, a first portion of the grille slats 320 are received by the grille apertures 316 when the grille slats 320 are coupled to the side brackets 306 and a second portion of the grille slats 320 are not received by the grille apertures 316. According to the embodiment shown in FIGS. 12 and 13, each of the side brackets 306 includes a plurality of side bracket extensions 318, extending rearward from a rear side of the side brackets 306. In other embodiments, each of the side brackets 306 includes a single of the side bracket extensions 318.

Referring to FIGS. 6, 9, and 11-13, a lowermost of the grille slats 320 is configured as a bottom grille slat 324, according to some embodiments. The bottom grille slat 324 may be positioned such that one of the grille openings 322 is not defined (e.g., not present, etc.) below the bottom grille slat 324. For example, a portion of the bottom grille slat 324 may contact the bottom bracket 304 of the grille frame assembly 302 such that one of the grille openings 322 is not present between the bottom grille slat 324 and the bottom bracket 304. In some embodiments, the bottom grille slat 324 and the bottom bracket 304 may form a seal such that air cannot flow between the bottom grille slat 324 and the bottom bracket 304. In some embodiments, the bottom grille slat 324 and the bottom bracket 304 are integrally formed (e.g., form a single weldment, welded, etc.). In other embodiments, the bottom grille slat 324 and the bottom bracket 304 are otherwise coupled together (e.g., fastened, etc.).

According to the embodiment shown in FIG. 9, the bottom grille slat 324 is formed with (e.g., configured to have, etc.) a different cross-sectional profile than a remainder of the grille slats 320 such that the bottom grille slat 324 may be positioned proximate the bottom bracket 304 of the grille frame assembly 302. For example, a lower portion of the bottom grille slat 324 may have a flat profile to interface with a top surface of the bottom bracket 304. According to the embodiment shown in FIG. 11-13, a bottom face of each of the side brackets 306 is configured to match a profile of a top surface of the bottom grille slat 324 such that the top surface of the bottom grille slat 324 aligns with the bottom face of the side brackets 306 when the bottom grille slat 324 is coupled to the side brackets 306 (e.g., when the bottom grille slat 324 does not align with one of the grille apertures 316, etc.). In some embodiments, the bottom face of each of the side brackets 306 and the top surface of the bottom grille slat 324 form a seal such that air cannot flow between the bottom face of each of the side brackets 306 and the top surface of the bottom grille slat 324.

According to the embodiment shown in FIG. 11-13, the grille frame assembly 302 includes a bottom back bracket 340 (e.g., bottom bracket, etc.) coupled to the side brackets 306 and extending between the side brackets 306. In some embodiments, the bottom back bracket 340 is coupled to the bottom grille slat 324. For example, a portion of the bottom grille slat 324 may contact the bottom back bracket 340 of the grille frame assembly 302 such that one of the grille openings 322 is not present between the bottom grille slat 324 and the bottom back bracket 340. In some embodiments, the bottom grille slat 324 and the bottom back bracket 340 may form a seal such that air cannot flow between the bottom grille slat 324 and the bottom back bracket 340.

As shown in FIG. 11-13, the bottom back bracket 340 includes a bottom back bracket back portion 342 positioned on a rearward end of the bottom back bracket 340. The bottom back bracket back portion 342 defines a bottom back bracket rearward surface (e.g., a first surface, etc.) on a rearward facing surface of the bottom back bracket back portion 342. The bottom back bracket 340 defines a bottom bracket aperture 344 extending through the bottom back bracket 340 and configured to selectively align with an aperture defined by the body 22 to receive a coupler (e.g., a screw, a bolt, etc.) to releasable couple the mounting bracket 310 to the body 22, and, thereby, the grille assembly 300 to the body 22. In some embodiments, the bottom back bracket 340 includes a threaded insert 346 that aligns with the bottom bracket aperture 344 to receive a threaded fastener extending through the aperture defined by the body 22. The threaded insert 346 may engage with the threaded fastener extending through the aperture defined by the body 22 and the bottom bracket aperture 344 to releasably couple the mounting bracket 310 to the body 22.

Referring to FIGS. 6, 9, and 11-13, an uppermost of the grille slats 320 is configured as a top grille slat 326, according to some embodiments. The top grille slat 326 may be positioned such that one of the grille openings 322 is not present above the top grille slat 326. For example, a portion of the top grille slat 326 may contact the top bracket 308 of the grille frame assembly 302 such that one of the grille openings 322 is not present between the top grille slat 326 and the top bracket 308. In some embodiments, the top grille slat 326 and the top bracket 308 may form a seal such that air cannot flow between the top grille slat 326 and the top bracket 308. In some embodiments, the top grille slat 326 and the top bracket 308 are integrally formed (e.g., form a single weldment, welded, etc.). In other embodiments, the top grille slat 326 and the top bracket 308 are otherwise coupled together (e.g., fastened, etc.).

According to the embodiment shown in FIG. 9, the top grille slat 326 is formed with (e.g., configured to have, etc.) a different cross-sectional profile than a remainder of the grille slats 320 such that the top grille slat 326 may be positioned proximate the top bracket 308 of the grille frame assembly 302. For example, a portion of the top grille slat 326 may have a flat profile to interface with a bottom surface of the top bracket 308 and an internal portion of the top grille slat 326 may be removed. According to the embodiment shown in FIG. 11-13, a top face of each of the side brackets 306 is configured to match a profile of a bottom surface of the top grille slat 326 such that the bottom surface of the top grille slat 326 aligns with the top face of the side brackets 306 when the top grille slat 326 is coupled to the side brackets 306 (e.g., when the top grille slat 326 does not align with one of the grille apertures 316, etc.). In some embodiments, the top face of each of the side brackets 306 and the bottom surface of the top grille slat 326 form a seal such that air cannot flow between the top face of each of the side brackets 306 and the bottom surface of the bottom grille slat 324.

According to the embodiment shown in FIG. 11-13, the grille frame assembly 302 includes a top back bracket 350 (e.g., a top bracket, etc.) coupled to the side brackets 306 and extending between the side brackets 306. In some embodiments, the top back bracket 350 is coupled to the top grille slat 326. For example, a portion of the top grille slat 326 may contact the top back bracket 350 of the grille frame assembly 302 such that one of the grille openings 322 is not present between the top grille slat 326 and the top back bracket 350. In some embodiments, the top grille slat 326 and the top back bracket 350 may form a seal such that air cannot flow between the top grille slat 326 and the top back bracket 350. The top back bracket 350 includes a top back bracket back portion 352 positioned on a rearward end of the top back bracket 350. The top back bracket back portion 352 defines a top back bracket rearward surface (e.g., a second surface, etc.) on a rearward facing surface of the top back bracket back portion 352.

According to the embodiment shown in FIGS. 12 and 14, the grille frame assembly 302 includes a center insert 360 coupled to the grille slats 320 and positioned between the side brackets 306. The center insert 360 is configured to support the grille slats 320 (e.g., support a center of the grille slats 320, etc.). In some embodiments, the center insert 360 is positioned equidistant from each of the side brackets 306 (e.g., positioned at a center between the side brackets 306, etc.). The center insert 360 defines a plurality of center grille apertures 362 configured to align with the grille slats 320 to receive the grille slats 320 when the grille slats 320 are coupled to the center insert 360. In some embodiments, a profile of the center grille apertures 362 may generally match a profile of the grille slats 320 which may assist with aligning the grille slats 320 relative to the grille frame assembly 302 when the grille slats 320 are coupled to the grille frame assembly 302 (e.g., during manufacturing, while being welded together, while being assembled, etc.). In various embodiments, a first portion of the grille slats 320 are received by the center grille apertures 362 when the grille slats 320 are coupled to the side brackets 306 and a second portion of the grille slats 320 are not received by the center grille apertures 362 (e.g., the bottom grille slat 324, the top grille slat 326, etc.). In some embodiments, the

According to the embodiment shown in FIG. 11-13, a bottom face of the center insert 360 is configured to match a profile of the top surface of the bottom grille slat 324 such that the top surface of the bottom grille slat 324 aligns with the bottom face of the center insert 360 when the bottom grille slat 324 is coupled to the side brackets 306 (e.g., when the bottom grille slat 324 does not align with one of the grille apertures 316, etc.). According to the embodiment shown in FIG. 11-13, a top face of the center insert 360 is configured to match a profile of a bottom surface of the top grille slat 326 such that the bottom surface of the top grille slat 326 aligns with the top face of the center insert 360 when the top grille slat 326 is coupled to the side brackets 306 (e.g., when the top grille slat 326 does not align with one of the grille apertures 316, etc.).

According to the embodiment shown in FIG. 12-15, the grille frame assembly 302 includes a pair of channel brackets 370 coupled to rear ends of the side brackets 306. For example, a first of the channel brackets 370 may be coupled to a rear end of a first of the side brackets 306 and a second of the channel brackets 370 may be coupled to a rear end of a second of the side brackets 306. The channel brackets 370 are configured to capture debris (e.g., fragments, spall, etc.) traveling along the sides of the grille slats 320 (e.g., the outward sides of the grille slates 320, the first end and the second opposing end of the grille slats 320, etc.). In some embodiments the channel brackets 370 are each coupled to at least one of the grille slats 320. The channel brackets 370 includes a channel back portion 372 coupled to the side brackets 306 and extending inward from the side brackets 306 and a channel side portion 374 coupled to the channel back portion 372 and at least partially extending forward from the channel back portion 372. The channel back portion 372 defines a channel rearward surface (e.g., third surfaces, etc.) on a rearward facing surface of the channel back portion 372. In some embodiments, the channel back portion 372 extends substantially perpendicular (e.g., perpendicular, etc.) to the side brackets 306. In some embodiments, the channel side portion 374 extends substantially perpendicular to the channel back portion 372. For example, a first portion of the channel side portion 374 may extend forward from the channel back portion 372 and may be oriented perpendicular to the channel back portion 372 and a second portion of the channel side portion 374 may extend rearward from the channel back portion 372 and may be oriented perpendicular to the channel back portion 372. According to various embodiments, the channel back portion 372 extends substantially parallel (e.g., parallel, etc.) to the mounting bracket 310 and/or the channel side portion 374 extends substantially parallel to the side brackets 306.

In some embodiments, the bottom back bracket rearward surface defined by the bottom back bracket back portion 342 of the bottom back bracket 340, the top back bracket rearward surface defined by the top back bracket back portion 352 of the top back bracket 350, and the channel rearward surfaces of the channel back portion 372 of the channel brackets 370 are substantially co-planar (e.g., co-planar, parallel, etc.). In some embodiments, the bottom back bracket rearward surface, the top back bracket rearward surface, and the channel rearward surfaces form a combined rearward surface (e.g., combined surface, etc.) of the grille frame assembly 302 (e.g., an unbroken surface, etc.). By way of example, a first of the channel rearward surfaces may be contiguous with the top back bracket rearward surface and the bottom back bracket rearward surface and a second of the channel rearward surfaces may be contiguous with the top back bracket rearward surface and the bottom bracket rearward surface. The combined rearward surface of the grille frame assembly 302 may be configured to interface with a seal (e.g., a gasket, etc.). For example, a seal may be received between the combined rearward surface of the grille frame assembly 302 and a radiator of the vehicle 10 to prevent air from flowing between the combined rearward surface of the grille frame assembly 302 and the radiator of the vehicle 10 such that all of the air flowing through the grille assembly 300 is provided to the radiator of the vehicle 10. As a result of the positioning of portions of the seal along the channel rearward surfaces of the channel back portions 372, the channel brackets 370 may prevent debris from contacting the portions of the seal that may otherwise damage the seal.

As shown in FIG. 12, each of the channel brackets 370 define a plurality of channel grille apertures 376 configured to align with the grille slats 320 to receive the grille slats 320 when the grille slats 320 are coupled to the side brackets 306. In some embodiments, a profile of the channel grille apertures 376 may generally match a profile of the grille slats 320 which may assist with aligning the grille slats 320 relative to the grille frame assembly 302 when the grille slats 320 are coupled to the grille frame assembly 302 (e.g., during manufacturing, while being welded together, while being assembled, etc.). In various embodiments, a first portion of the grille slats 320 are received by the channel grille apertures 376 when the grille slats 320 are coupled to the side brackets 306 and a second portion of the grille slats 320 are not received by the channel grille apertures 376 (e.g., the bottom grille slat 324, the top grille slat 326, etc.).

According to the embodiment shown in FIG. 11-13, bottom faces of the channel side portion 374 of the channel brackets 370 are configured to match a profile of the top surface of the bottom grille slat 324 such that the top surface of the bottom grille slat 324 aligns with the bottom faces of the channel side portion 374 when the bottom grille slat 324 is coupled to the side brackets 306 (e.g., when the bottom grille slat 324 does not align with one of the grille apertures 316, etc.). According to the embodiment shown in FIG. 11-13, top faces of the channel side portion 374 of the channel brackets 370 are configured to match a profile of a bottom surface of the top grille slat 326 such that the bottom surface of the top grille slat 326 aligns with the top faces of the channel side portion 374 when the top grille slat 326 is coupled to the side brackets 306 (e.g., when the top grille slat 326 does not align with one of the grille apertures 316, etc.).

According to the embodiment shown in FIG. 12, each of the channel back portion 372 of the channel brackets 370 defines a plurality of extension apertures 378 configured to align with the side bracket extensions 318 to receive the side bracket extensions 318 when the side brackets 306 are coupled to the channel brackets 370, which may assist with aligning the channel brackets 370 relative to the side brackets 306 when the channel brackets 370 are coupled to the side brackets 306. (e.g., during manufacturing, while being welded together, while being assembled, etc.). In other embodiments, each of the channel back portions 372 define a single of the extrusion apertures configured to align with the single of the side bracket extensions 318 (e.g., when the side brackets 306 include the single of the side bracket extensions 318, etc.).

In some embodiments, the grille slats 320 are formed from a rigid material. The grille slats 320 may be formed from materials that is suitable for impact resistance (e.g., fracture resistance, tough material, etc.) such as high strength steel, stainless steel, and titanium. In some embodiments, the grille slats 320 are formed from an armor steel (e.g., a AR500 alloy, a MIL-A-46100 alloy, etc.). In some embodiments, the grille slats 320 are formed using hot stamping methods. Beneficially, forming the grille slats 320 using hot stamping methods allows for the grille slats 320 to each be formed from blanks. As a result, a quantity of material required to form each of the grille slats 320 may be reduced relative to when the grille slats 320 are formed using other methods (e.g., welded together, bent out of sheet metal, etc.). Additionally, forming the grille slats 320 using hot stamping methods may result in enhanced material properties of the grille slats 320 due to the grille slats 320 each being formed from the blanks relative to using other methods. For example, the grille slats 320 may have uniform material properties due to each of the grille slats 320 being formed from single pieces of continuous material (e.g., pieces of monolithic material, being unibody components, being unified components, etc.). As a result, the grille slats 320 may have uniform material properties from being formed from the blanks. Additionally, forming the grille slats 320 using hot stamping methods may allow for the grille slats 320 to include profiles that may not be feasible to create using alternate manufacturing techniques. For example, a die used during the hot stamping process may be able to form unique profiles of the grille slats 320.

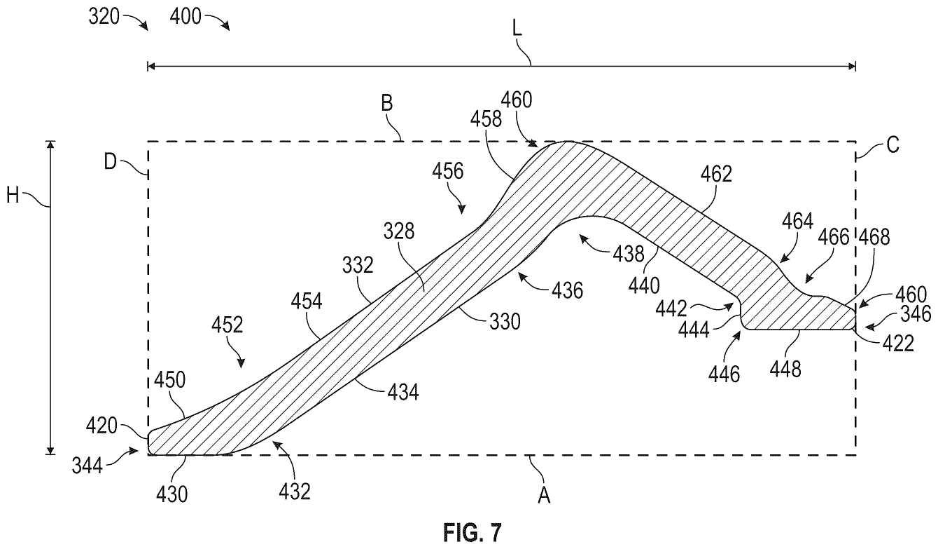

Referring to FIGS. 7, 10, and 16, according to some embodiments, each of the grille slats 320 have a grille body 328, a bottom surface 330 (e.g., a first surface, a lower surface, etc.) extending along a bottom (e.g., an lower side, etc.) of the grille body 328, a top surface 332 (e.g., a second surface, an upper surface.) extending along a top (e.g., an upper side, etc.) of the grille body 328, an external end 334 (e.g., a forward end, an end proximate an environment surrounding the vehicle 10, etc.) of the grille body 328 positioned proximate an outer end of the grille assembly 300, and an internal end 336 (e.g., a rearward end, an end proximate an inside of the vehicle 10, etc.) of the grille body 328 positioned proximate an inner end of the grille assembly 300. In some embodiments, at least a portion of the grille body 328 has a thickness of approximately 4-9 mm, or approximately 5-8 mm, or approximately 6-7 mm. For example, a majority of the grille body 328 may have a thickness of approximately 4-9 mm, or approximately 5-8 mm, or approximately 6-7 mm. In some embodiments, a first portion of the grille body 328 position proximate the external end 334 is tapered such that a first thickness of the first portion of the grille body 328 proximate the external end 334 is less than a second thickness of a second portion of the grille body 328 positioned rearward of the first portion of the grille body 328.

According to the embodiment shown in FIG. 7, the grille slats 320 are configured as bent knee grille slats 400 (e.g., rounded top grille slats, etc.). In some embodiments, the bent knee grille slats 400 include a first blunt edge 420 (e.g., a first smooth edge, a first rounded edge, etc.) positioned proximate the external end 334 of the bent knee grille slats 400. In some embodiments, the bent knee grille slats 400 include a second blunt edge 422 (e.g., a second smooth edge, a second rounded edge, etc.) positioned proximate the internal end 336 of the bent knee grille slats 400.

As shown in FIG. 7, a bottom profile of the bottom surface 330 of the bent knee grille slat 400 includes a first bottom flat portion 430 (e.g., a first lower surface, etc.), a first bottom curvature 432 (e.g., a second lower surface, etc.), a second bottom flat portion 434 (e.g., a third lower surface, etc.), a second bottom curvature 436 (e.g., a fourth lower surface, etc.), a third bottom curvature 438 (e.g., a fifth lower surface, etc.), a third bottom flat portion 440 (e.g., a sixth lower surface, etc.), a fourth bottom curvature 442 (e.g., a seventh lower surface, etc.), a fourth bottom flat portion 444 (e.g., an eighth lower surface, etc.), a fifth bottom curvature 446 (e.g., a ninth lower surface, etc.), and a fifth bottom flat portion 448 (e.g., a tenth lower surface, etc.) from the first blunt edge 420 to the second blunt edge 422, according to some embodiments. The first bottom flat portion 430 is positioned proximate the first blunt edge 420 and is contiguous with the first blunt edge 420. In some embodiments, the first bottom flat portion 430 is configured to be substantially parallel to the top surface of the bottom bracket 304 and to the bottom surface of the top bracket 308 when the grille slats 320 are coupled to the pair of side brackets 306 of the grille frame assembly 302. As shown in FIG. 7, the first bottom flat portion 430 defines a plane (A) aligned with the first bottom flat portion 430. In some embodiments, the plane (A) is substantially parallel to the ground surface 20. In other embodiments, the plane (A) is angled relative to the ground surface 20 (e.g., when the grille assembly 300 is mounted on an angled surface of the body 22 of the vehicle 10, etc.).

As shown in FIG. 7, the first bottom curvature 432 is contiguous (e.g., continuous, etc.) with first bottom flat portion 430 and extends rearward from the first bottom flat portion 430. The first bottom curvature 432 is a convex curvature relative to the grille body 328. The second bottom flat portion 434 is contiguous with the first bottom curvature 432 and is positioned rearward of the first bottom curvature 432. The first bottom curvature 432 changes an orientation of the bottom surface 330 from the first bottom flat portion 430 to the second bottom flat portion 434 such that the second bottom flat portion 434 is angled upward relative to the plane (A) and/or the first bottom flat portion 430. For example, the second bottom flat portion 434 may be oriented at a first angle relative to the plane (A) (e.g., the second bottom flat portion 434 and the plane (A) form the first angle, etc.).

As shown in FIG. 7, the second bottom curvature 436 is contiguous with the second bottom flat portion 434 and extends rearward from the second bottom flat portion 434. The second bottom curvature 436 is a convex curvature relative to the grille body 328. The second bottom curvature 436 changes the orientation of the bottom surface 330 from the second bottom flat portion 434 such that a portion of the bottom surface 330 positioned rearward of the second bottom curvature 436 is angled upward relative to the second bottom flat portion 434. The portion of the bottom surface 330 positioned rearward of the second bottom curvature 436 may be angled further upward relative to the plane (A) than the second bottom flat portion 434. For example, the portion of the bottom surface 330 positioned rearward of the second bottom curvature 436 may be oriented at a second angle relative to the plane (A) that is greater than the first angle between the second bottom flat portion 434 and the plane (A).

As shown in FIG. 7, the third bottom curvature 438 is contiguous with the second bottom curvature 436 and extends rearward from the second bottom curvature 436. The third bottom flat portion 440 is continuous with the third bottom curvature 438 and extends rearward from the third bottom curvature 438. The third bottom curvature 438 is a concave curvature relative to the grille body 328. The third bottom curvature 438 changes the orientation of the bottom surface 330 from the portion of the bottom surface 330 positioned rearward of the second bottom curvature 436 such that the third bottom flat portion 440 such that the third bottom flat portion 440 is angled downward relative to the portion of the bottom surface 330 positioned rearward of the second bottom curvature 436. The third bottom flat portion 440 may be angled downward relative to the plane (A). For example, the third bottom flat portion 440 and the plane (A) may form a third angle that is less than the first angle and the second angle (e.g., since the third angle is a negative angle, etc.). In some embodiments, the second bottom curvature 436 and the third bottom curvature 438 such that the third bottom flat portion 440 is oriented substantially perpendicular to the second bottom flat portion 434.

As shown in FIG. 7, the fourth bottom curvature 442 is contiguous with the third bottom flat portion 440 and extends rearward from the third bottom flat portion 440. The fourth bottom flat portion 444 is contiguous with the fourth bottom curvature 442 and extends rearward from the fourth bottom curvature 442. The fourth bottom curvature 442 changes the orientation of the bottom surface 330 from the third bottom flat portion 440 to the fourth bottom flat portion 444 such that the fourth bottom flat portion 444 is angled downward relative to the third bottom flat portion 440. the fourth bottom flat portion 444 may be angled further downward relative to the plane (A) than the fourth bottom curvature 442. For example, the fourth bottom flat portion 444 may be oriented at a fourth angle relative to the plane (A) that is less than the third angle between the fourth bottom curvature 442 and the plane (A). (e.g., since the fourth angle is more negative than the third angle, a first magnitude of the fourth angle is greater than a second magnitude of the third angle, etc.). In some embodiments, the fourth bottom flat portion 444 is oriented perpendicular to the plane (A).

As shown in FIG. 7, the fifth bottom curvature 446 is contiguous with the fourth bottom flat portion 444 and extends rearward from the fourth bottom flat portion 444. The fifth bottom flat portion 448 is contiguous with the fifth bottom curvature 446, is contiguous with the third top curvature 460, and extends rearward from the fourth bottom curvature 442. The fifth bottom curvature 446 changes the orientation of the bottom surface 330 from the fourth bottom flat portion 444 to the fifth bottom flat portion 448 such that the fifth bottom flat portion 448 is angled upward relative to the fourth bottom flat portion 444. The fifth bottom flat portion 448 may be angled further upward relative to the plane (A) than the fourth bottom flat portion 444. For example, the fifth bottom flat portion 448 may be oriented at a fifth angle relative to the plane (A) that is greater than the fourth angle between the fourth bottom flat portion 444 and the plane (A). In some embodiments, the fifth bottom flat portion 448 is oriented parallel to the plane (A) (e.g., the fifth angle is equal to zero, etc.). In some embodiments, the fifth bottom flat portion 448 is positioned above the plane (A). The fifth bottom flat portion 448 is positioned closer to the plane (A) than the third bottom curvature 438. For example, a lowermost portion of the fifth bottom flat portion 448 may be positioned a first distance from the plane (A) and a lowermost portion of the third bottom curvature 438 may be positioned a second distance from the plane (A), the second distance larger than the first distance.

As shown in FIG. 7, a top profile of the bottom surface 330 of the bent knee grille slat 400 includes a first top flat 450 (e.g., a first upper surface, etc.), a first top curvature 452 (e.g., a second upper surface, etc.), a second top flat 454 (e.g., a third upper surface, etc.), a second top curvature 456 (e.g., a fourth upper surface, etc.), a third top flat 458 (e.g., a fifth upper surface, etc.), a third top curvature 460 (e.g., a sixth upper surface, etc.), a fourth top flat 462 (e.g., a seventh upper surface, etc.), a fourth top curvature 464 (e.g., an eighth upper surface, etc.), a fifth top curvature 466 (e.g., a ninth upper surface, etc.), and a fifth top flat 468 (e.g., a tenth upper surface, etc.) from the first blunt edge 420 to the second blunt edge 422, according to some embodiments. The first top curvature 452 is positioned proximate the first blunt edge 420 and is contiguous with the first blunt edge 420. In some embodiments, the first top curvature 452 is angled upward relative to the first bottom flat portion 430 (e.g., angled upward relative to the plane (A), etc.). For example, the first top curvature 452 may be oriented at a sixth angle relative to the plane (A). In other embodiments, the first top curvature 452 is oriented parallel to the plane (A) (e.g., parallel to the first bottom flat portion 430, etc.).

As shown in FIG. 7, the first top curvature 452 is contiguous with the first top flat 450 and extends rearward from the first top flat 450. The first top curvature 452 is a concave curvature relative to the grille body 328. The second top flat 454 is contiguous with the first top curvature 452 and extends rearward from the first top curvature 452. The first top curvature 452 changes an orientation of the top surface 332 from the first top flat 450 to the second top flat 454 such that the second top flat 454 is angled upward relative to the first top flat 450. The second top flat 454 may be angled further upward relative to the plane (A) than the first top flat 450. For example, the second top flat 454 may be oriented at a seventh angle relative to the plane (A) that is greater than the sixth angle between the first top flat 450 and the plane (A). In some embodiments the second top flat 454 is oriented parallel to the second bottom flat portion 434. The thickness of a portion of the grille body 328 positioned between the second top flat 454 and the second bottom flat portion 434 may be constant. For example, the second top flat 454 may be oriented parallel to the second bottom flat portion 434 and the second top flat 454 may be positioned on an opposing side of the grille body 328 relative to the second bottom flat portion 434.

As shown in FIG. 7, the second top curvature 456 is contiguous with the second top flat 454 and extends rearward from the second top flat 454. The second top curvature 456 is a concave curvature relative to the grille body 328. The third top flat 458 is contiguous with the second top curvature 456 and extends rearward from the second top curvature 456. The second top curvature 456 changes the orientation of the top surface 332 from the second top flat 454 to the third top flat 458 such that the third top flat 458 is angled upward relative to the second top flat 454. The third top flat 458 may be angled further upward relative to the plane (A) than the second top flat 454. For example, the third top flat 458 may be oriented at an eighth angle relative to the plane (A) that is greater than the seventh angle between the second top flat 454 and the plane (A).

As shown in FIG. 7, the third top curvature 460 is contiguous with the third top flat 458 and extends rearward from the third top flat 458 The third top curvature 460 is a convex curvature relative to the second top flat 454. The fourth top flat 462 is contiguous with the third top curvature 460 and extends rearward from the third top curvature 460. The third top curvature 460 changes the orientation of the top surface 332 from the third top flat 458 to the fourth top flat 462 such that the fourth top flat 462 is angled downward relative to the third top flat 458. The fourth top flat 462 may be angled downward relative to the plane (A). For example, the fourth top flat 462 may be oriented at a ninth angle relative to the plane (A) that is less than the eighth angle between the third top flat 458 and the plane (A) (e.g., since the ninth angle is negative, etc.). In some embodiments, the fourth top flat 462 is oriented parallel to the third bottom flat portion 440. The thickness of a portion of the grille body 328 positioned between the fourth top flat 462 and the third bottom flat portion 440 may be constant. For example, the fourth top flat 462 may be oriented parallel to the third bottom flat portion 440 and the second top flat 454 may be positioned on an opposing side of the grille body 328 relative to the second bottom flat portion 434.

In some embodiments, the thickness of the grille body 328 is greater proximate in a portion of the grille body 328 proximate the third top flat 458 and the third top curvature 460. For example, the profile of the top surface 332 may move further from the profile of the second bottom flat portion 434 proximate the third top flat 458 and the third top curvature 460 than in other portions of the grille body 328.

As shown in FIG. 7, the fourth top curvature 464 is contiguous with the fourth top flat 462 and extends rearward from the fourth top flat 462. The fourth top curvature 464 is a convex curvature relative to the grille body 328. The fourth top curvature 464 changes the orientation of the top surface 332 from the fourth top flat 462 such that a portion of the top surface 332 positioned rearward of the fourth top curvature 464 is angled downward relative to the fourth top flat 462. The portion of the top surface 332 positioned rearward of the fourth top curvature 464 may be angled further downward relative to the plane (A) than the fourth top flat 462. For example, the portion of the top surface 332 positioned rearward of the fourth top curvature 464 may be oriented at a tenth angle relative to the plane (A) that is less than the ninth angle between the fourth top flat 462 and the plane (A) (e.g., since the tenth angle is more negative than the ninth angle, a third magnitude of the tenth angle is greater than a fourth magnitude of the ninth angle, etc.).

As shown in FIG. 7, the fifth top curvature 466 is contiguous with the fourth top curvature 464 and extends rearward from the fourth top curvature 464. The fifth top curvature 466 is a concave curvature relative to the grille body 328. The fifth top flat 468 is contiguous with the fifth top curvature 466, is contiguous with the third top curvature 460, and extends rearward from the fifth top curvature 466. The fifth top curvature 466 changes the orientation of the top surface 332 from the portion of the top surface 332 positioned rearward of the fourth top curvature 464 such that the fifth top flat 468 is angled upward relative to the portion of the top surface 332 positioned rearward of the fourth top curvature 464. The fifth top flat 468 may be angled further upward relative to the plane (A) than the portion of the top surface 332 positioned rearward of the fourth top curvature 464. For example, the fifth top flat 468 may be oriented at an eleventh angle relative to the plane (A) that is less than the tenth angle between the portion of the top surface 332 positioned rearward of the fourth top curvature 464 and the plane (A) (e.g., since the eleventh angle is less negative than the tenth angle, a fifth magnitude of the eleventh angle is less than the fourth magnitude of the tenth angle, etc.). In some embodiments, the fifth top flat 468 is angled downward relative to the plane (A). In other embodiments, the fifth top flat 468 is oriented parallel to the plane (A).

Still referring to FIG. 7, the bent knee grille slats 400 have a height (H) between the plane (A) aligned with the first bottom flat portion 430 and a plane (B) aligned with an uppermost portion of the third top curvature 460, the plane (B) oriented parallel to the plane (A). In some embodiments, the height H is approximately 36-44 mm, or approximately 38-42 mm, or approximately 39-41 mm. In other embodiments, the length H may be other lengths. The bent knee grille slats 400 have a length (L) between a plane (C) aligned with a forwardmost portion of the first blunt edge 420 and a plane (D) aligned with a rearmost portion of the second blunt edge 422. The plane (C) is oriented parallel to the plane (D) and the plane (C) and the plane (D) are oriented perpendicular to the plane (A) and the plane (B). According to the embodiment shown in FIG. 7, the length L is approximately 80-100 mm, or approximately 86-94 mm, or approximately 89-91 mm. In other embodiments, the length L may be other lengths.

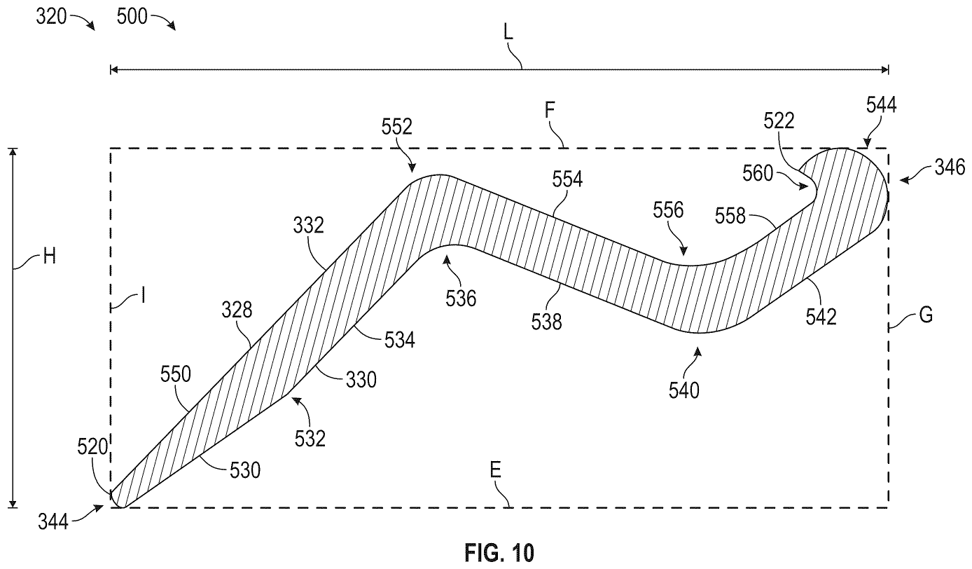

According to the embodiment shown in FIG. 10, the grille slats 320 are configured as chevron grille slats 500 (e.g., pointed grille slats, etc.). In some embodiments, the chevron grille slats 500 include a first blunt edge 520 (e.g., a first smooth edge, a first rounded edge, etc.) positioned proximate the external end 334 of the chevron grille slats 500. In some embodiments, the chevron grille slats 500 include a second edge 522 (e.g., a second sharp edge, a second non-rounded edge, etc.) positioned proximate the internal end 336 of the chevron grille slats 500. As shown in FIG. 10, a bottom portion of the first blunt edge 520 defines a plane (E) that is parallel to the top surface of the bottom bracket 304 and to the bottom surface of the top bracket 308 when the grille slats 320 are coupled to the pair of side brackets 306 of the grille frame assembly 302. In some embodiments, the plane (E) is substantially parallel to the ground surface 20. In other embodiments, the plane (E) is angled relative to the ground surface 20 (e.g., when the grille assembly 300 is mounted on an angled surface of the body 22 of the vehicle 10, etc.).

As shown in FIG. 10, a bottom profile of the bottom surface 330 of the chevron grille slats 500 includes a first bottom flat portion 530, a first bottom curvature 532, a second bottom flat portion 534, a second bottom curvature 536, a third bottom flat portion 538, a third bottom curvature 540, a fourth bottom flat portion 542, and a fourth bottom curvature 544 from the first blunt edge 520 to the second edge 522, according to some embodiments. The first bottom flat portion 530 is positioned proximate the first blunt edge 520 and is contiguous with the first blunt edge 520. In some embodiments, the first bottom flat portion 530 is oriented upward relative to the plane (E). For example, the first bottom flat portion 530 may be oriented at a first angle relative to the plane (E). In other embodiments, the first bottom flat portion 530 is oriented parallel to the plane (E).

As shown in FIG. 10, the first bottom curvature 532 is contiguous with the first bottom flat portion 530 and extends rearward from the first bottom flat portion 530. The first bottom curvature 532 is a convex curvature relative to the grille body 328. The second bottom flat portion 534 is contiguous with the first bottom curvature 532 and extends rearward from the first bottom curvature 532. The first bottom curvature 532 changes an orientation of the bottom surface 330 from the first bottom flat portion 530 to the second bottom flat portion 534 such that the second bottom flat portion 534 is angled upward relative to the first bottom flat portion 530. The second bottom flat portion 534 may be angled further upward relative to the plane (E) than the first bottom flat portion 530. For example, the second bottom flat portion 534 may be oriented at a second angle relative to the plane (E) that is larger than the first angle between the first bottom flat portion 530 and the plane (E).

As shown in FIG. 10, the second bottom curvature 536 is contiguous with the second bottom flat portion 534 and extends rearward from the second bottom flat portion 534. The second bottom curvature 536 is a concave curvature relative to the grille body 328. The third bottom flat portion 538 is contiguous with the second bottom curvature 536 and extends rearward from the third bottom flat portion 538. The second bottom curvature 536 changes the orientation of the bottom surface 330 from the second bottom flat portion 534 to the third bottom flat portion 538 such that the third bottom flat portion 538 is angled downward relative to the second bottom flat portion 534. The third bottom flat portion 538 may be angled downward relative to the plane (E). For example, the third bottom flat portion 538 may be oriented at a third angle relative to the plane (E) that is less than the second angle between the second bottom flat portion 534 and the plane (E) (e.g., because the third angle is negative, etc.). In some embodiments, the third bottom flat portion 538 is oriented perpendicular to the second bottom flat portion 534.

As shown in FIG. 10, the third bottom curvature 540 is contiguous with the third bottom flat portion 538 and extends rearward from the third bottom flat portion 538. The third bottom curvature 540 is a convex curvature relative to the grille body 328. The fourth bottom flat portion 542 is contiguous with the third bottom curvature 540 and extends rearward from the third bottom curvature 540. The third bottom curvature 540 changes the orientation of the bottom surface 330 from the third bottom flat portion 538 to the fourth bottom flat portion 542 such that the fourth bottom flat portion 542 is angled upward relative to the third bottom flat portion 538. The fourth bottom flat portion 542 may be angled upward relative to the plane (E). For example, the fourth bottom flat portion 542 may be oriented at a fourth angle relative to the plane (E) that is greater than the third angle between the third bottom flat portion 538 and the plane (E). In some embodiments, the fourth bottom flat portion 542 is oriented perpendicular to the third bottom flat portion 538. In some embodiments, the fourth bottom flat portion 542 is oriented parallel to the first bottom flat portion 530 or the second bottom flat portion 534.

As shown in FIG. 10, the fourth bottom curvature 544 is contiguous with the fourth bottom flat portion 542, is contiguous with the second edge 522, and extends rearward from the fourth bottom flat portion 542. The fourth bottom curvature 544 is a convex curvature relative to the grille body 328. In some embodiments, the fourth bottom curvature 544 changes the orientation of the bottom surface 330 between the fourth bottom flat portion 542 and the second edge 522 such that orientation of the bottom surface 330 is pivoted approximately 180 degrees between the fourth bottom flat portion 542 and the second edge 522. For example, a portion of the fourth bottom curvature 544 proximate the second edge 522 may be substantially parallel to the fourth bottom flat portion 542. In other embodiments, the fourth bottom curvature 544 changes the orientation of the bottom surface 330 between the fourth bottom flat portion 542 and the second edge 522 such that the orientation of the bottom surface 330 is pivoted less than 180 degrees (e.g., 90 degrees, etc.).

As shown in FIG. 10, a top profile of the top surface 332 of the chevron grille slats 500 includes a first top flat portion 550, a first top curvature 552, a second top flat portion 554, a second top curvature 556, a third top flat portion 558, and a third top curvature 560 from the first blunt edge 520 to the second edge 522, according to some embodiments. The first top flat portion 550 is positioned proximate the first blunt edge 520 and is contiguous with the first blunt edge 520. In some embodiments, the first top flat portion 550 is oriented upward relative to the plane (E). For example, the first top flat portion 550 may be oriented at a fifth angle relative to the plane (E). The fifth angle between the first top flat portion 550 and the plane (E) may be greater than the first angle between the first bottom flat portion 530 and the plane (E) such that the first top flat portion 550 and the first bottom flat portion 530 form a wedge shape proximate the bottom bracket aperture 344. In some embodiments, the first top flat portion 550 is oriented parallel to the second bottom flat portion 534. The thickness of a portion of the grille body 328 positioned between the first top flat portion 550 and the second bottom flat portion 534 may be constant. For example, the first top flat portion 550 may be oriented parallel to the second bottom flat portion 534 and at least a portion of the first top flat portion 550 may be positioned on an opposing side of the grille body 328 relative to the second bottom flat portion 534.

As shown in FIG. 10, the first top curvature 552 is contiguous with the first top flat portion 550 and extends rearward from the first top flat portion 550 The first top curvature 552 is a convex curvature relative to the grille body 328. The second top flat portion 554 is contiguous with the first top curvature 552 and extends rearward from the first top curvature 552. The first top curvature 552 changes an orientation of the top surface 332 from the first top flat portion 550 to the second top flat portion 554 such that the second top flat portion 554 is angled downward relative to the first top flat portion 550. The second top flat portion 554 may be angled downward relative to the plane (E). For example, the second top flat portion 554 may be oriented at a sixth angle relative to the plane (E) that is less than the fifth angle between the first top flat portion 550 and the plane (E) (e.g., because the sixth angle is negative, etc.). In some embodiments, the second top flat portion 554 is oriented perpendicular to the first top flat portion 550.

In some embodiments, the second top flat portion 554 is oriented parallel to the third bottom flat portion 538. The thickness of a portion of the grille body 328 positioned between the second top flat portion 554 and the third bottom flat portion 538 may be constant. For example, the second top flat portion 554 may be oriented parallel to the third bottom flat portion 538 and at least a portion of the second top flat portion 554 may be positioned on an opposing side of the grille body 328 relative to the second bottom flat portion 534. In some embodiments, the thickness of the portion of the grille body 328 positioned between the second top flat portion 554 and the third bottom flat portion 538 is equal to the thickness of the portion of the grille body 328 positioned between the first top flat portion 550 and the second bottom flat portion 534.

As shown in FIG. 10, the second top curvature 556 is contiguous with the second top flat portion 554 and extends rearward from the second top flat portion 554. The second top curvature 556 is a convex curvature relative to the grille body 328. The third top flat portion 558 is contiguous with the second top curvature 556 and extends rearward from the second top flat portion 554. The second top curvature 556 changes the orientation of the top surface 332 from the second top flat portion 554 to the third top flat portion 558 such that the third top flat portion 558 is angled upward relative to the second top flat portion 554. The third top flat portion 558 may be angled upward relative to the plane (E). For example, the third top flat portion 558 may be oriented at a seventh angle relative to the plane (E) that is greater than the sixth angle between the second top flat portion 554 and the plane (E). In some embodiments, the third top flat portion 558 is oriented perpendicular to the second top flat portion 554. In some embodiments, the third top flat portion 558 is oriented parallel to the first top flat portion 550.

In some embodiments, the third top flat portion 558 is oriented parallel to the fourth bottom flat portion 542. The thickness of a portion of the grille body 328 positioned between the third top flat portion 558 and the fourth bottom flat portion 542 may be constant. For example, the third top flat portion 558 may be oriented parallel to the fourth bottom flat portion 542 and at least a portion of the third top flat portion 558 may be positioned on an opposing side of the grille body 328 relative to the fourth bottom flat portion 542. In some embodiments, the thickness of the portion of the grille body 328 positioned between the third top flat portion 558 and the fourth bottom flat portion 542 is equal to the thickness of the portion of the grille body 328 positioned between the second top flat portion 554 and the third bottom flat portion 538 and/or equal to the thickness of the portion of the grille body 328 positioned between the first top flat portion 550 and the second bottom flat portion 534.

As shown in FIG. 10, the third top curvature 560 is contiguous with the third top flat portion 558, is contiguous with the first top curvature 552, and extends rearward from the third top flat portion 558. The third top curvature 560 is a concave curvature relative to the grille body 328. In some embodiments, the third top curvature 560 changes the orientation of the top surface 332 between the third top flat portion 558 and the first top curvature 552 such that the orientation of the bottom surface 330 is pivoted greater than 90 degrees between the third top flat portion 558 and the second edge 522. For example, a portion of the third top curvature 560 proximate the second edge 522 may be substantially perpendicular to the third top flat portion 558. In other embodiments, the third top curvature 560 changes the orientation of the top surface 332 between the third top flat portion 558 and the second edge 522 such that the orientation of the top surface 332 is pivoted less than 90 degrees (e.g., 45 degrees, etc.).

In some embodiments, a first radius of curvature of the third top curvature 560 is smaller than a second radius of curvature of the fourth bottom curvature 544 such that the chevron grille slats 500 takes on a hook shape curling toward the forward end of the chevron grille slats 500 proximate the second edge 522. As a result, the thickness of the grille body 328 decreases as the grille body 328 moves toward the second edge 522.

Still referring to FIG. 10, the chevron grille slats 500 have a height (H) between the plane (E) aligned with the first blunt edge 520 and a plane (F) aligned with an uppermost portion of the fourth bottom curvature 544, the plane (F) oriented parallel to the plane (E). In some embodiments, the height H is approximately 36-44 mm, or approximately 38-42 mm, or approximately 39-41 mm. In other embodiments, the length H may be other lengths. The chevron grille slats 500 have a length (L) between a plane (I) aligned with a forwardmost portion of the first blunt edge 520 and a plane (G) aligned with a rearmost portion of the fourth bottom curvature 544. The plane (G) is oriented parallel to the plane (I) and the plane (I) and the plane (G) are oriented perpendicular to the plane (E) and the plane (F). According to the embodiment shown in FIG. 10, the length L is approximately 75-98 mm, or approximately 82-91 mm, or approximately 85-88 mm. In other embodiments, the length L may be other lengths.

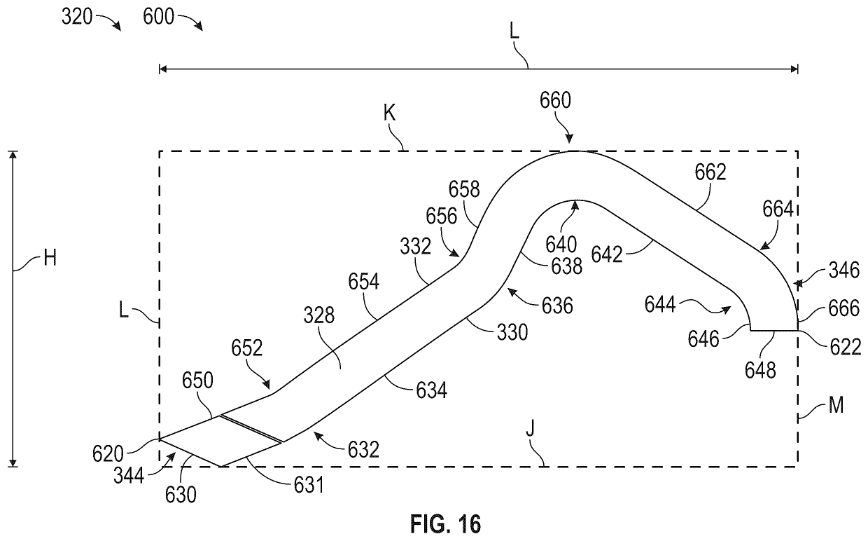

According to the embodiment shown in FIG. 16, the grille slats 320 are configured as modified bent knee grille slats 600 (e.g., bent knee grille slats, etc.). The modified bent knee grille slats 600 include a pointed edge 620 (e.g., a sharp edge, a blade edge, etc.) positioned proximate the external end 334 of the modified bent knee grille slats 600. The pointed edge 620 may be configured to direct air flowing through the grille assembly 300 around the modified bent knee grille slats 600 and through the grille openings 322. The modified bent knee grille slats 600 include a rear edge 622 positioned proximate the internal end 336 of the modified bent knee grille slats 600.

As shown in FIG. 16, a bottom profile of the bottom surface 330 of the modified bent knee grille slats 600 includes a first bottom flat portion 630, a second bottom flat portion 631, a first bottom curvature 632, a third bottom flat portion 634, a second bottom curvature 636, a fourth bottom flat portion 638, a third bottom curvature 640, a fifth bottom flat portion 642, a fourth bottom curvature 644, a sixth bottom flat portion 646, and a seventh bottom flat portion 648 from the pointed edge 620 to the rear edge 622, according to some embodiments. The second bottom flat portion 631 is contiguous with the pointed edge 620 and extends rearward from the pointed edge 620. In some embodiments, the second bottom flat portion 631 extends downward from the pointed edge 620. The second bottom flat portion 631 is contiguous with the first bottom flat portion 630 and extends rearward from the first bottom flat portion 630. The second bottom flat portion 631 changes the orientation of the first bottom flat portion 630 such that the second bottom flat portion 631 extends upward relative to the first bottom flat portion 630.

The first bottom flat portion 630 and the second bottom flat portion 631 define a plane (J) at an intersection between the first bottom flat portion 630 and the second bottom flat portion 631 (e.g., a lowermost point on the modified bent knee grille slats 600, etc.). The plane (J) is perpendicular to the rearward surface of the mounting bracket 310 when the grille slats 320 is coupled to the grille frame assembly 302. In some embodiments, the plane (J) is perpendicular to an inside surface of the side brackets 306 when the grille slats 320 is coupled to the grille frame assembly 302. In some embodiments, the plane (J) is substantially parallel to the ground surface 20. In other embodiments, the plane (J) is angled relative to the ground surface 20 (e.g., when the grille assembly 300 is mounted on an angled surface of the body 22 of the vehicle 10, etc.).

In some embodiments, the first bottom flat portion 630 is oriented downwards towards the plane (J). In some embodiments, the second bottom flat portion 631 is oriented upward relative to the plane (J). For example, the second bottom flat portion 631 may be oriented at a first angle relative to the plane (J). In other embodiments, the second bottom flat portion 631 is oriented parallel to the plane (J).

As shown in FIG. 16, the first bottom curvature 632 is contiguous with the second bottom flat portion 631 and extends rearward from the second bottom flat portion 631. The first bottom curvature 632 is a convex curvature relative to the grille body 328. The third bottom flat portion 634 is contiguous with the first bottom curvature 632 and extends rearward from the first bottom curvature 632. The first bottom curvature 632 changes an orientation of the bottom surface 330 from the second bottom flat portion 631 to the third bottom flat portion 634 such that the third bottom flat portion 634 is angled upward relative to the second bottom flat portion 631. The third bottom flat portion 634 may be angled further upward relative to the plane (J) than the second bottom flat portion 631. For example, the third bottom flat portion 634 may be oriented at a second angle relative to the plane (J) that is larger than the first angle between the second bottom flat portion 631 and the plane (J).

As shown in FIG. 16, the second bottom curvature 636 is contiguous with the third bottom flat portion 634 and extends rearward from the third bottom flat portion 634. The second bottom curvature 636 is a convex curvature relative to the grille body 328. The fourth bottom flat portion 638 is contiguous with the second bottom curvature 636 and extends rearward from the third bottom flat portion 634. The second bottom curvature 636 changes the orientation of the bottom surface 330 from the third bottom flat portion 634 to the fourth bottom flat portion 638 such that the fourth bottom flat portion 638 is angled upward relative to the third bottom flat portion 634. The fourth bottom flat portion 638 may be angled further upward relative to the plane (J) than the third bottom flat portion 634. For example, the fourth bottom flat portion 638 may be oriented at a third angle relative to the plane (J) that is larger than the second angle between the third bottom flat portion 634 and the plane (J).

As shown in FIG. 16, the third bottom curvature 640 is contiguous with the fourth bottom flat portion 638 and extends rearward from the fourth bottom flat portion 638. The bottom back bracket 340 is a convex curvature relative to the grille body 328. The fifth bottom flat portion 642 is contiguous with the third bottom curvature 640 and extends rearward from the third bottom curvature 640. The third bottom curvature 640 changes the orientation of the bottom surface 330 from the fourth bottom flat portion 638 to the fifth bottom flat portion 642 such that the fifth bottom flat portion 642 is angled downward relative to the fourth bottom flat portion 638. The fifth bottom flat portion 642 may be angled downward relative to the plane (J). For example, the fifth bottom flat portion 642 may be orientated at a fourth angle relative to the plane (J) that is less than the third angle between the fourth bottom flat portion 638 and the plane (J) (e.g., because the fourth angle is negative, etc.). In some embodiments, the fifth bottom flat portion 642 is oriented perpendicular to at least one of the second bottom flat portion 631, the third bottom flat portion 634 or the fourth bottom flat portion 638.

As shown in FIG. 16, the fourth bottom curvature 644 is contiguous with the fifth bottom flat portion 642 and extends rearward from the fifth bottom flat portion 642 The fourth bottom curvature 644 is a convex curvature relative to the grille body 328. The sixth bottom flat portion 646 is contiguous with the fourth bottom curvature 644 and extends rearward from the fourth bottom curvature 644. The fourth bottom curvature 644 changes the orientation of the bottom surface 330 from the fifth bottom flat portion 642 to the sixth bottom flat portion 646 such that the sixth bottom flat portion 646 is angled downward relative to the fifth bottom flat portion 642. The fourth top curvature 464 may be angled further downward relative to the plane (J) than the fifth bottom flat portion 642. For example, the fourth top curvature 464 may be oriented at a fifth angle relative to the plane (J) that is less than the fourth angle between the fifth bottom flat portion 642 and the plane (J) (e.g., because the fourth angle and the fifth angle are negative, etc.). In some embodiments, the fourth top curvature 464 is oriented perpendicular to the plane (J).

As shown in FIG. 16, the fifth top flat 468 is contiguous with the sixth bottom flat portion 646, is contiguous with the rear edge 622, and extends rearward from the sixth bottom flat portion 646 to the rear edge 622. The seventh bottom flat portion 648 changes the orientation of the bottom surface 330 from the sixth bottom flat portion 646 such that the seventh bottom flat portion 648 is angled upward relative to the sixth bottom flat portion 646. The seventh bottom flat portion 648 may be angled further upward relative to the plane (J) than the sixth bottom flat portion 646. For example, the seventh bottom flat portion 648 may be angled at a sixth angle relative to the plane (J) that is greater than the fifth angle between the sixth bottom flat portion 646 and the plane (J). In some embodiments, the seventh bottom flat portion 648 is oriented parallel to the plane (J) (e.g., the sixth angle is equal to zero, etc.). In some embodiments, the seventh bottom flat portion 648 is oriented perpendicular to the sixth bottom flat portion 646.

In some embodiments, the seventh bottom flat portion 648 is positioned above the plane (J). The seventh bottom flat portion 648 is positioned closer to the plane (J) than the third bottom curvature 640. For example, a lowermost portion of the seventh bottom flat portion 648 may be positioned a first distance from the plane (J) and a lowermost portion of the third bottom curvature 640 may be positioned a second distance from the plane (J), the second distance larger than the first distance.

As shown in FIG. 16, a top profile of the top surface 332 of the modified bent knee grille slats 600 includes a first top flat portion 650, a first top curvature 652, a second top flat portion 654, a second top curvature 656, a third top flat portion 658, a third top curvature 660, a fourth top flat portion 662, a fourth top curvature 664, and a fifth top flat portion 666 from the pointed edge 620 to the rear edge 622, according to some embodiments. The first top flat portion 650 is positioned proximate the pointed edge 620 and is contiguous with the pointed edge 620. In some embodiments, the first top flat portion 650 is oriented upward relative to the plane (J). For example, the first top flat portion 650 may be oriented at a seventh angle relative to the plane (J).

In some embodiments, the first top flat portion 650 is oriented parallel to the second bottom flat portion 631. The thickness of a portion of the grille body 328 positioned between the first top flat portion 650 and the second bottom flat portion 631 may be constant. For example, the first top flat portion 650 may be oriented parallel to the second bottom flat portion 631 and at least a portion of the first top flat portion 650 may be positioned on an opposing side of the grille body 328 relative to the second bottom flat portion 631.

As shown in FIG. 16, the first top curvature 652 is contiguous with the first top flat portion 650 and extends rearward from the first top flat portion 650. The first top curvature 652 is a concave curvature relative to the grille body 328. The second top flat portion 654 is contiguous with the first top curvature 652 and extends rearward from the first top curvature 652. The first top curvature 652 changes an orientation of the top surface 332 from the first top flat portion 650 to the second top flat portion 654 such that the second top flat portion 654 is angled upward relative to the first top flat portion 650. The second top flat portion 654 may be angled further upward relative to the plane (J) than the first top flat portion 650. For example, the second top flat portion 654 may be oriented at an eighth angle relative to the plane (J) that is greater than the seventh angle between the first top flat portion 650 and the plane (J).

In some embodiments, the second top flat portion 654 is oriented parallel to the third bottom flat portion 634. The thickness of a portion of the grille body 328 positioned between the second top flat portion 654 and the third bottom flat portion 634 may be constant. For example, the second top flat portion 654 may be oriented parallel to the third bottom flat portion 634 and at least a portion of the second top flat portion 654 may be positioned on an opposing side of the grille body 328 relative to the third bottom flat portion 634. In some embodiments, the thickness of the portion of the grille body 328 positioned between the second top flat portion 654 and the third bottom flat portion 634 is equal to the thickness of the portion of the grille body 328 positioned between the first top flat portion 650 and the second bottom flat portion 631.

As shown in FIG. 16, the second top curvature 656 is contiguous with the second top flat portion 654 and extends rearward from the second top flat portion 654. The second top curvature 656 is a concave curvature relative to the grille body 328. The third top flat portion 658 is contiguous with the second top curvature 656 and extends rearward from the second top curvature 656. The second top curvature 656 changes the orientation of the top surface 332 from the second top flat portion 654 to the third top flat portion 658 such that the third top flat portion 658 is angled upward relative to the second top flat portion 654. The third top flat portion 658 may be angled further upward relative to the plane (J) than the second top flat portion 654. For example, the third top flat portion 658 may be oriented at a ninth angle relative to the plane (J) that is greater than the eight angle between the second top flat portion 654 and the plane (J).

In some embodiments, the third top flat portion 658 is oriented parallel to the fourth bottom flat portion 638. The thickness of a portion of the grille body 328 positioned between the third top flat portion 658 and the fourth bottom flat portion 638 may be constant. For example, the third top flat portion 658 may be oriented parallel to the fourth bottom flat portion 638 and at least a portion of the third top flat portion 658 may be positioned on an opposing side of the grille body 328 relative to the fourth bottom flat portion 638. In some embodiments, the thickness of the portion of the grille body 328 positioned between the third top flat portion 658 and the fourth bottom flat portion 638 is equal to the thickness of the portion of the grille body 328 positioned between the first top flat portion 650 and the second bottom flat portion 631 and/or to the thickness of the portion of the grille body 328 positioned between the second top flat portion 654 and the third bottom flat portion 634.

As shown in FIG. 16, the third top curvature 660 is contiguous with the third top flat portion 658 and extends rearward from the third top flat portion 658. The third top curvature 660 is a convex curvature relative to the grille body 328. The fourth top flat portion 662 is contiguous with the third top curvature 660 and extends rearward from the third top curvature 660. The third top curvature 660 changes the orientation of the top surface 332 from the third top flat portion 658 to the fourth top flat portion 662 such that the fourth top flat portion 662 is angled downward relative to the third top flat portion 658. The fourth top flat portion 662 may be angled downward relative to the first top flat portion 650 and/or the second top flat portion 654. The fourth top flat portion 662 may be angled downward relative to the plane (J). For example, the fourth top flat portion 662 may be oriented at a tenth angle relative to the plane (J) that is less than the ninth angle between the third top flat portion 658 and the plane (J) (e.g., because the tenth angle is negative, etc.).

In some embodiments, the fourth top flat portion 662 is oriented parallel to the fifth bottom flat portion 642. The thickness of a portion of the grille body 328 positioned between the fourth top flat portion 662 and the fifth bottom flat portion 642 may be constant. For example, the fourth top flat portion 662 may be oriented parallel to the fifth bottom flat portion 642 and at least a portion of the fourth top flat portion 662 may be positioned on an opposing side of the grille body 328 from the fifth bottom flat portion 642. In some embodiments, the thickness of the portion of the grille body 328 positioned between the fourth top flat portion 662 and the fifth bottom flat portion 642 is equal to the thickness of the portion of the grille body 328 positioned between the third top flat portion 658 and the fourth bottom flat portion 638, the portion of the grille body 328 positioned between the first top flat portion 650 and the second bottom flat portion 631 and/or to the thickness of the portion of the grille body 328 positioned between the second top flat portion 654 and the third bottom flat portion 634.

As shown in FIG. 16, the fourth top curvature 664 is contiguous with the fourth top flat portion 662 and extends rearward from the fourth top flat portion 662. The fourth top curvature 664 is a convex curvature relative to the grille body 328. The fifth top flat portion 666 is contiguous with the fourth top curvature 664, is contiguous with the rear edge 622, and extends rearward from the fourth top curvature 664. The fourth top curvature 664 changes the orientation of the top surface 332 from the fourth top flat portion 662 to the fifth top flat portion 666 such that the fifth top flat portion 666 is angled downward relative to the fourth top curvature 664. The fifth top flat portion 666 may be angled further downward relative to the plane (J) than the fourth top flat portion 662. For example, the fifth top flat portion 666 may be oriented at an eleventh angle relative to the plane (J) that is less than the tenth angle between the fourth top flat portion 662 and the plane (J) (e.g., because the tenth angle and the eleventh angle are negative, etc.).

In some embodiments, the fifth top flat portion 666 is oriented parallel to the sixth bottom flat portion 646. The thickness of a portion of the grille body 328 positioned between the fifth top flat portion 666 and the sixth bottom flat portion 646 may be constant. For example, the fifth top flat portion 666 may be oriented parallel to the sixth bottom flat portion 646 and at least a portion of the fifth top flat portion 666 may be positioned on an opposing side of the grille body 328 from the sixth bottom flat portion 646. In some embodiments, the thickness of the portion of the grille body 328 positioned between the fifth top flat portion 666 and the sixth bottom flat portion 646 is equal to the thickness of the portion of the grille body 328 positioned between the fourth top flat portion 662 and the fifth bottom flat portion 642, the portion of the grille body 328 positioned between the third top flat portion 658 and the fourth bottom flat portion 638, the portion of the grille body 328 positioned between the first top flat portion 650 and the second bottom flat portion 631 and/or to the thickness of the portion of the grille body 328 positioned between the second top flat portion 654 and the third bottom flat portion 634.

Still referring to FIG. 16, the modified bent knee grille slats 600 have a height (H) between the plane (J) aligned with the intersection between the first bottom flat portion 630 and the second bottom flat portion 631 and a plane (K) aligned with an uppermost portion of the third top curvature 660. In some embodiments, the height H is approximately 38-46 mm, or approximately 40-44 mm, or approximately 41-43 mm. In other embodiments, the length H may be other lengths. The modified bent knee grille slats 600 also have a length (L) between a plane (L) aligned with the pointed edge 620 a plane (M) aligned with the rear edge 622. The plane (M) is oriented parallel to the plane (L) and the plane (M) and the plane (L) are oriented perpendicular to the plane (J) and the plane (K). According to the embodiment shown in FIG. 16, the length L is approximately 75-95 mm, or approximately 81-89 mm, or approximately 84-86 mm. In other embodiments, the length L may be other lengths.

### Method for Forming a Grille Slat

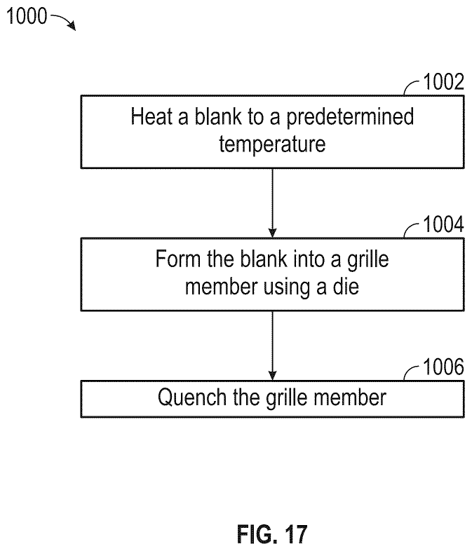

Referring now to FIG. 17, a flowchart for a process 1000 of forming a grille slat of an armored grille assembly includes steps 1002-1006, according to some embodiments. In some embodiments, the process 1000 is performed to form the grille slats 320 of the grille assembly 300. In some embodiments, the process 1000 is performed to form the bent knee grille slats 400, the chevron grille slats 500, and/or the modified bent knee grille slats 600.

The process 1000 includes heating a blank to a predetermined temperature (step 1002), according to some embodiments. In some embodiments, a material of the blank may be a high strength steel, a stainless steel, or a titanium. For example, the blank may be made of an armor steel (e.g., a AR500 alloy, a MIL-A-46100 alloy, etc.). In some embodiments, the blank may be shaped to a predetermined blank size prior to being heated to the predetermined temperature. For example, the blank may be cut from a larger piece of stock prior to heating the blank to the predetermined temperature. In some embodiments, the blank may have a thickness that corresponds with a desired thickness of the grille slat of the armored grille assembly that is being formed. For example, the blank may have a thickness of 6-7 mm if a majority of the grille slat being formed has a desired thickness of 6.5 mm. In some embodiments, the predetermined temperature may be a temperature that is between an austenitizing temperature (e.g., a transformation temperature, etc.) and a melting point of the material of the blank. For example, the blanks may be heated until the temperature of the blank is within a temperature range that allows for the blank to be hot stamped into a shape. In some embodiments, the blanks are heated to the predetermined temperature placing the blank into a furnace. In other embodiments, the blank may be heated using alternative methods (e.g., induction heating, resistance heating, etc.).

The process 1000 includes forming the blank into a grille slat using a die (step 1004), according to some embodiments. In some embodiments, the die may form the blank into the grille slat by applying a pressure on the blank for a predetermined amount of time. For example, the die may apply the pressure on the blank for five minutes to for the blank into the grille slat. In some embodiments, the die may be part of a press configured to apply pressure to the blank through the die. For example, the blank may be placed between a top die and a bottom die, and the press may apply a force on the top die and the bottom die such that the top die and the bottom die apply a pressure on the blank. The pressure from the top die and the bottom die may shape the blank into a shape desired for the grille slat. In some embodiments, a temperature of the blank is above a forming temperature when being formed into the grille slat using the die. For example, the blank may be heated above the predetermined temperature and then the step of forming the blank into the grille slat is performed before the temperature of the blank drops below a forming temperature where the blank may no longer be formed using the die. In some embodiments, the die is configured to transfer heat to the blank while the die is forming the blank into the grille slat. For example, the die may include a heater configured to increase the temperature of the die above an ambient temperature.

The process 1000 includes quenching the grille slat (step 1006), according to some embodiments. In some embodiments, the grille slat may be quenched in a fluid to rapidly decrease the temperature of the grille slat to achieve desired material properties of the grille slat. For example, the grille slat may be dipped into an oil to decrease the temperature of the grille slat and to create a desired grain structure in the material of the grille slat. In some embodiments, the grille slat may be quenched in order to increase a hardness of the grille slat. For example, it may be desirable to increase the hardness of the grille slat to prevent damage to the grille slats if objects come into contact with the grille slat.

In some embodiments, process 1000 includes tempering the grille slat. In some embodiments, the grille slat may be heated to a tempering temperature and held at the temperature temperature for a tempering period of time. For example, after the grille slat has been quenched, the grille slat may be reheated to a temperature lower than the predetermined temperature of step 1002 in order to temper the grille slat. In some embodiments, the grille slat may be tempered in order to increase a toughness of the grille slat. For example, it may be desirable to increase the toughness of the grille slat to prevent the grille slat from fracturing due to brittleness if objects come into contact with the grille slat.

In some embodiments, process 1000 includes additional machining operations to form the grille slat. For example, after the die has formed the blank into the grille slat, the grille slat may be machined in order to finish forming the grille slat. In some embodiments, it may not be possible to form all features of the grille slat using hot stamping. For example, the first blunt edge 520 of the chevron grille slat 500 may be machined using a CNC after the blank has been formed into the chevron grille slat 500 in order to achieve a desired level of accuracy on a radius of the first blunt edge 520.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle 10 as shown in the various exemplary embodiments is illustrative only. Additionally, any element disclosed in one embodiment may be incorporated or utilized with any other embodiment disclosed herein.

What is claimed is:

1. A vehicle comprising:
a chassis;
a body coupled to the chassis; and
a grille assembly coupled to the body, the grille assembly comprising:
a grille frame assembly coupled to the body, and
a plurality of grille slats coupled to the grille frame assembly, the plurality of grille slats spaced across the grille frame assembly to define a plurality of grille openings through the grille assembly that provide indirect paths through the grille assembly.

2. The vehicle of claim 1, wherein each of the grille slats includes a pointed edge positioned at forward ends of the grille slats.

3. The vehicle of claim 1, wherein a bottom profile of a bottom surface of each of the grille slats comprises:
a first flat portion;
a first curvature portion contiguous with the first flat portion and extending rearward from first flat portion, the first curvature portion forming a convex curvature;
a second flat portion contiguous with the first curvature portion and extending rearward from the first curvature;
a second curvature portion contiguous with the second flat portion and extending rearward from the second flat portion, the second curvature portion forming a concave curvature; and
a third flat portion contiguous with the second curvature portion and extending rearward from the second curvature portion.

4. The vehicle of claim 3, wherein the bottom profile of the bottom surface of each of the grille slats further comprises:
a third curvature portion contiguous with the third flat portion and extending rearward from the third flat portion, the third curvature portion forming a concave curvature; and
a fourth flat curvature portion contiguous with the third curvature portion.

5. The vehicle of claim 1, wherein:
a bottom profile of a bottom surface of each of the grille slats comprises:
a first flat portion;
a first curvature portion contiguous with the first flat portion and extending rearward from first flat portion, the first curvature portion forming a concave curvature; and
a second flat portion contiguous with the first curvature portion and extending rearward from the first curvature; and
a first thickness of each of the grille slats proximate the first curvature portion is larger than a second thickness proximate the first flat portion.

6. The vehicle of claim 1, wherein:
a bottom profile of a bottom surface of each of the grille slats comprises:
a first flat portion;
a first curvature portion contiguous with the first flat portion and extending rearward from first flat portion, the first curvature portion forming a concave curvature; and
a second flat portion contiguous with the first curvature portion and extending rearward from the first curvature; and
the first curvature portion changes an orientation of the bottom surface from the first flat portion to the second flat portion such that the second flat portion is angled downward relative to the first flat portion.

7. The vehicle of claim 1, wherein:
a bottom profile of a bottom surface of each of the grille slats comprises:
a first flat portion;
a first curvature portion contiguous with the first flat portion and extending rearward from first flat portion, the first curvature portion forming a convex curvature; and
a second flat portion contiguous with the first curvature portion and extending rearward from the first curvature; and
the first curvature portion changes an orientation of the bottom surface from the first flat portion to the second flat portion such that the second flat portion is angled further upward relative to the first flat portion.

8. The vehicle of claim 1, wherein:
a thickness of each of the grille slats is substantially constant from forward ends of the grille slats to rearward ends of the grille slats, the rearward ends of the grille slats opposing the forward ends of the grille slats, such that a top profile of the grille slats substantially matches a bottom profile of the grille slats.

9. The vehicle of claim 1, wherein the grille frame assembly comprises:
a mounting bracket coupled to the body; and
a pair of side brackets coupled the mounting bracket at opposing sides of the mounting bracket and coupled to each of the grille slats at opposing ends of the grille slats.

10. The vehicle of claim 9, wherein the mounting bracket defines an intake opening extending through the mounting bracket and aligned with the grille openings.

11. The vehicle of claim 1, wherein the grille frame assembly comprises a pair of side brackets coupled to each of the grille slats at opposing ends of the grille slats, each of the side brackets defining a plurality of apertures that align with and receive the grille slats.

12. The vehicle of claim 1, wherein the grille frame assembly further comprises:
a pair of side brackets coupled to each of the grille slats at opposing ends of the grille slats; and
a center insert coupled to the grille slats and positioned between the side brackets, the center insert defining a plurality of apertures that align with and receive the grille slats.

13. The vehicle of claim 1, wherein each of the indirect paths follow a zig-zag shape through the grille assembly.

14. A grille assembly configured to couple to a body of a vehicle, the grille assembly comprising:
a grille frame assembly configured to couple to the body, the grille frame assembly comprising:
a mounting bracket configured to couple to the body, the mounting bracket defining an intake opening extending through the mounting bracket, and
a pair of side brackets coupled the mounting bracket at opposing sides of the mounting bracket, each of the side brackets defining a first plurality of apertures; and
a plurality of grille slats coupled to the mounting bracket and aligning with and extending through the first plurality of apertures, the plurality of grille slats spaced across the grille frame assembly to define a plurality of grille openings through the grille assembly that provide indirect paths through the grille assembly.

15. The grille assembly of claim 14, wherein the grille frame assembly further comprises:
a center insert coupled to the grille slats and positioned between the side brackets, the center insert defining a second plurality of apertures that align with and receive the grille slats.

16. The grille assembly of claim 14, wherein the grille frame assembly further comprises:
a pair of channel brackets, each of the channel brackets coupled to a rear end of the side brackets, each of the channel brackets having:
a channel back portion coupled to the side brackets and extending inward from the side brackets; and
a channel side portion coupled to the channel back portion and extending forward from the channel back portion, the channel side portion.

17. The grille assembly of claim 16, wherein the grille frame assembly further comprises:
a top bracket coupled to the side brackets and positioned above the grille slats; and
a bottom bracket coupled to the side brackets and positioned below the grille slats;
wherein a first rearward surface of the top bracket, a second rearward surface of the bottom bracket, and a third rearward surface of a first of the channel brackets, and a fourth rearward surface of a second of the channel brackets form a continuous rearward surface of the grille frame assembly extending around the intake opening.

18. The grille assembly of claim 14, wherein:
each of the indirect paths include a first portion at a first end of the indirect paths and a second portion at a second end of the indirect paths, the second end opposite the first end; and
a portion of at least one of the grille slats is positioned between the first portions of the indirect paths and the second portions of the indirect paths.

19. A method of forming a grille slat, the method comprising:
heating a blank to a predetermined temperature;
forming the blank into the grille slat using a die by applying pressure with the die on the blank with a temperature of the blank above a forming temperature; and
quenching the grille slat by submerging the grille slat in a fluid to decrease the temperature of the grille slat.

20. The method of claim 19, wherein a bottom profile of a bottom surface of the grille slat comprises:
a first flat portion;
a first curvature portion contiguous with the first flat portion and extending rearward from first flat portion, the first curvature portion forming a convex curvature;
a second flat portion contiguous with the first curvature portion and extending rearward from the first curvature;
a second curvature portion contiguous with the second flat portion and extending rearward from the second flat portion, the second curvature portion a concave curvature; and
a third flat portion contiguous with the second curvature portion and extending rearward from the second curvature portion.
